(19) United States
(12) Patent Application Publication
(10) Pub. No.: US 2026/0134633 A1
(43) Pub. Date: May 14, 2026

(54) STORAGE MEDIUM, INFORMATION PROCESSING SYSTEM, AND GAME PROCESSING METHOD

(71) Applicant: NINTENDO CO., LTD., Kyoto (JP)

(72) Inventor: Tatsuya KURIHARA, Kyoto (JP)

(21) Appl. No.: 19/379,593

(22) Filed: Nov. 4, 2025

(30) Foreign Application Priority Data
Nov. 11, 2024 (JP) 2024-196730

(51) Int. Cl. G06T 17/20; A63F 13/56

(52) U.S. Cl. CPC G06T 17/205; A63F 13/56; A63F 2300/66; G06T 2210/21

(57) ABSTRACT

An example of an information processing system generates and updates a voxel mesh in which vertex coordinates of a mesh are determined based on at least densities and intersection, based on voxel data in which at least a density is set for each of a plurality of voxels and intersection information is set for at least some voxels. The information processing system decreases the densities of voxels in the voxel data corresponding to a voxel update range that is set based on the position where an action is performed by a player character, and deletes the intersection information if the intersection information is set for voxels in the voxel data corresponding to an intersection information update range. The information processing system renders a virtual space including the voxel mesh.

### CROSS REFERENCE TO RELATED APPLICATION

This application claims priority to Japanese Patent Application No. 2024-196730, filed on Nov. 11, 2024, the entire contents of which are incorporated herein by reference.

### FIELD

The technique shown here relates to a storage medium, an information processing system, and a game processing method for generating an object in a virtual space.

### BACKGROUND AND SUMMARY

Conventionally, when a mesh of an object is generated, information on a normal direction at a certain position is defined to determine vertices of polygons such that the plane of each polygon is perpendicular to the normal direction at the position.

It is desired to suppress an increase in processing load in the process of generating a mesh of an object by using the information.
(1)

An example of one or more non-transitory computer-readable media having stored therein instructions that, when executed, cause one or more processors to execute information processing comprising: generating and updating a voxel mesh based on voxel data, defined in a voxel space in a virtual space, in which at least a density is set for each of a plurality of voxels, the density indicating a degree of occupation of a content in a space defined by the voxel, and in which intersection information regarding an intersection of a mesh and a line connecting voxels is set for at least some voxels, wherein vertex coordinates of the voxel mesh are determined based on at least the densities and the intersection information; based on an operation input, controlling a player character in the virtual space, and causing the player character to perform a first action in response to a first user instruction based on the operation input; decreasing the densities of voxels in the voxel data corresponding to a first voxel update range that is set based on a position where the first action is performed, and deleting the intersection information if the intersection information is set for voxels in the voxel data corresponding to a first intersection information update range that is set based on the position where the first action is performed; and
rendering the virtual space including the voxel mesh.

According to the configuration of the above (1), an increase in processing load in the process of generating a voxel mesh by using intersection information can be suppressed.
(2)

In the configuration of the above (1), the intersection information may include, for each voxel, data indicating coordinates of an intersection and data indicating a normal direction, the intersection being an intersection between a mesh and a boundary between the voxel and an adjacent voxel in a first direction. A vertex of the voxel mesh may be set between a voxel whose density has a value in a first range and a voxel whose density has a value in a second range. Regarding a voxel for which the intersection information is set, coordinates of the vertex of the voxel mesh may be determined, based on the intersection information, at a position where a plane of the voxel mesh is arranged facing the normal direction at the coordinates of the intersection, or an error of the plane of the voxel mesh from the arrangement is minimized. The information processing may comprise, regarding a voxel for which intersection information is not set, based on an intersection that is set based on the density, generating and updating the voxel mesh based on determining the coordinates of the vertex of the voxel mesh.

According to the configuration of the above (2), the shape of the voxel mesh can be defined more specifically according to the intersection information.
(3)

In the configuration of the above (2), the information processing may comprise generating and updating the voxel mesh, based on determining the coordinates of the vertex of the voxel mesh at a position where the distance from a plurality of planes, which are based on a plurality of pieces of intersection information and face the normal direction at the coordinates of intersection, is minimized.

According to the configuration of the above (3), the vertex of the voxel mesh can be set on a plane defined by the intersection information, or at a position close to the plane.
(4)

In the configuration of the any one of above (1) to (3), the information processing may further comprise: causing the player character to perform a second action in response to a second user instruction based on an operation input; and for voxels in the voxel data corresponding to a second voxel update range that is set in response to the second action, decreasing the densities without deleting the intersection information.

According to the configuration of the above (4), when the decreased density is restored, the shape of the voxel mesh can be generated by using the intersection information. Therefore, the shape of the voxel mesh can be restored to the original shape more accurately.
(5)

In the configuration of the above (4), the voxel data may include first voxel data defined in a first voxel space and second voxel data defined in a second voxel space. The first action may be an action for the first voxel data, and the first voxel update range is an update range for the first voxel data. The second action may be an action for the second voxel data, and the second voxel update range is an update range for the second voxel data.

According to the configuration of the above (5), regarding deformation of a voxel object in response to the first action, an increase in processing load in the process of generating a voxel mesh by using intersection information can be suppressed. Regarding deformation of a voxel object in response to the second action, the shape of the voxel mesh can be restored to the original shape more accurately.
(6)

In the configuration of the above (5), the voxel data may further include third voxel data which is defined in a third voxel space, and in which, for each of a plurality of voxels, a correspondence relationship with each of voxels in the second voxel data is set. The information processing may further comprise, when the density of a voxel in the second voxel data is decreased, increasing the density of an increase target voxel which is a voxel in the third voxel data and on which the correspondence relationship with a decrease target voxel, which is the voxel whose density is decreased, is set.

According to the configuration of the above (6), it is possible to perform a representation in which the volume of one voxel object seems to increase in response to a decrease in volume of the other voxel object.
(7)

In the configuration of the any one of above (1) to (3), the voxel data may further include: first voxel data defined in a first voxel space; second voxel data defined in a second voxel space; and third voxel data which is defined in a third voxel space, and in which, for each of a plurality of voxels, a correspondence relationship with each of voxels in the second voxel data is set. The information processing may further comprise: when the density of a voxel in the second voxel data is decreased based on the first action, increasing the density of an increase target voxel which is a voxel in the third voxel data and on which the correspondence relationship with a decrease target voxel, which is the voxel whose density is decreased, is set; and when the intersection information has been set for the decrease target voxel, setting the same intersection information as the intersection information deleted from the decrease target voxel, on the increase target voxel.

According to the configuration of the above (7), an increase in processing load regarding generation of a mesh based on the second voxel data can be suppressed. In addition, regarding generation of a mesh based on the third voxel data, the mesh can be generated so as to more accurately reproduce the same shape as the voxel object regarding the second voxel data.
(8)

In the configuration of the any one of above (1) to (7), the information processing may further comprise: causing the player character to perform a third action in response to a third user instruction based on an operation input; and for voxels in the voxel data corresponding to a third voxel update range that is set in response to the third action, updating the densities of the voxels, and setting the intersection information for at least some of the voxels.

According to the configuration of the above (8), even when intersection information is not set for a voxel object before deformation, it is easier to shape the mesh of the deformed voxel object as intended.
(9)

In the configuration of the any one of above (1) to (8), the voxel data may include at least fourth voxel data which is defined in a fourth voxel space and in which the intersection information is set for at least some of the voxels. The information processing may further comprise, when the density of a voxel in the fourth voxel data is decreased based on the first action, for a voxel in the fourth voxel data corresponding to a fourth voxel update range, increasing the density of the voxel and restoring the intersection information deleted based on the first action.

According to the configuration of the above (9), the shape of the voxel object can be restored to the shape before deformation more accurately.

The present specification discloses an example of an information processing device and an information processing system that execute the processes in the above (1) to (9). Moreover, the present specification discloses an example of a game processing method with which the information processing system executes the processes in the above (1) to (9).

According to the storage medium, the information processing system, the information processing device, or the game processing method, an increase in processing load in the process of generating a mesh of an object can be suppressed.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a view showing an example of voxel data;

FIG. 12 is a view showing an example of material data;

FIG. 13 is a view showing an example of a game space when an update event has occurred;

FIG. 14 is a view showing an example of an update range;

FIG. 15 is a view showing an example of a method for setting vertices;

FIG. 16 is a view showing an example of a method for determining vertices in the case where intersection information is set;

FIG. 17 is a view showing an example of a method for determining vertices in the case where intersection information different from that shown in FIG. 16 is set;

FIG. 18 is a view showing an example of intersection information data;

FIG. 19 is a view showing an example of vertex simplification;

FIG. 20 is a view showing an example of conditions regarding materials;

FIG. 21 is a view showing an example of a mesh generated based on vertices;

FIG. 22 is a view showing an example of a game image representing a state in which a player character moves on a terrain object;

FIG. 23 is a view showing an example of a game image representing a state in which the player character pulls out a fragment object from the terrain object;

FIG. 24 is a view showing an example of a game image representing a state in which a fragment object is generated because the player character has destroyed the terrain object;

FIG. 25 is a view showing an example of a game image in a state where the player character can perform a throwing action;

FIG. 26 is a view showing an example of a game image after a change is added to the terrain object because a fragment object has come into contact with the terrain object shown in FIG. 25;

FIG. 27 is a view showing an example of a game image in a case where intersection information is set for a terrain object;

FIG. 28 is a view showing an example of game images before and after a terrain object is deformed in the state shown in FIG. 27;

FIG. 29 is a view showing an example of an update range and a deletion range set for a terrain object;

FIG. 30 is a view showing an example of a game image representing a game space in which first correspondence objects are placed;

FIG. 31 is a view showing an example of a game image representing a state after a punching action has been performed from the state shown in FIG. 30;

FIG. 32 is a view showing an example of a game image representing a state after a punching action has been further performed to the first correspondence objects from the state shown in FIG. 31;

FIG. 33 is a view showing an example of a game image representing a state after a punching action has been performed to a second correspondence object in the state shown in FIG. 32;

FIG. 34 is a view showing an example of density values that are set for voxels of the first correspondence object and the second correspondence object;

FIG. 35 is a view showing an example of intersection information set to a correspondence object;

FIG. 36 is a view showing an example of a game image in a state where a part of a terrain object is deformed as if it rises upward;

FIG. 37 is a view showing an example of a state in which a character object is restored after deformation;

FIG. 38 is a view showing an example of various data used for information processing in the non-limiting game system;

FIG. 39 is a flowchart showing an example of a flow of game processing executed by the non-limiting game system;

FIG. 40 is a sub flowchart showing an example of a specific flow of a voxel update process in step S4 shown in FIG. 39;

FIG. 41 is a sub flowchart showing an example of a specific flow of an intersection information control process in step S24 shown in FIG. 40;

FIG. 42 is a sub flowchart showing an example of a specific flow of a correspondence object update process in step S5 shown in FIG. 39; and

FIG. 43 is a sub flowchart showing an example of a specific flow of an effect setting process in step S13 shown in FIG. 39.

### DETAILED DESCRIPTION OF NON-LIMITING EXAMPLE EMBODIMENTS

### 1. Configuration of Game System

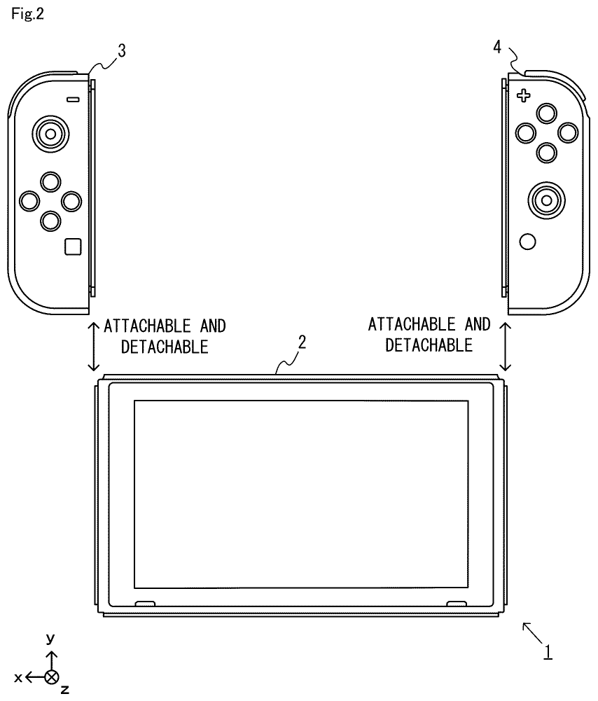

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

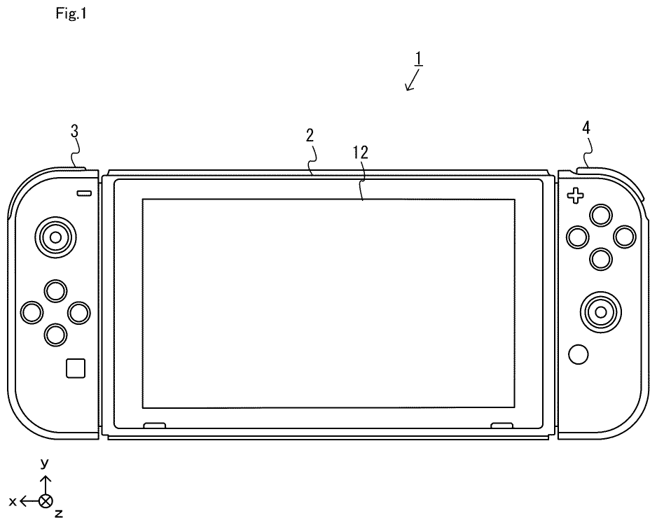

FIG. 1 is a diagram showing an example of the state in which the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state in which each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

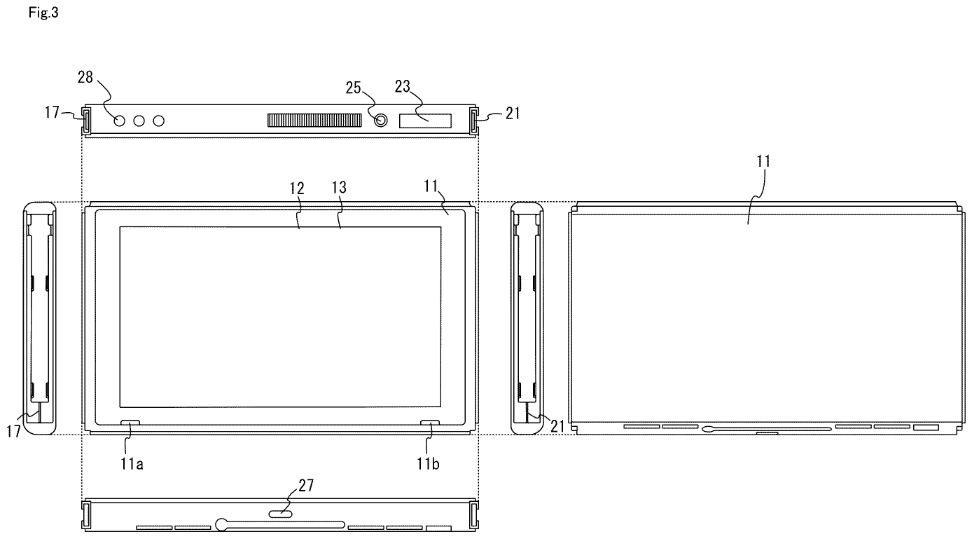

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

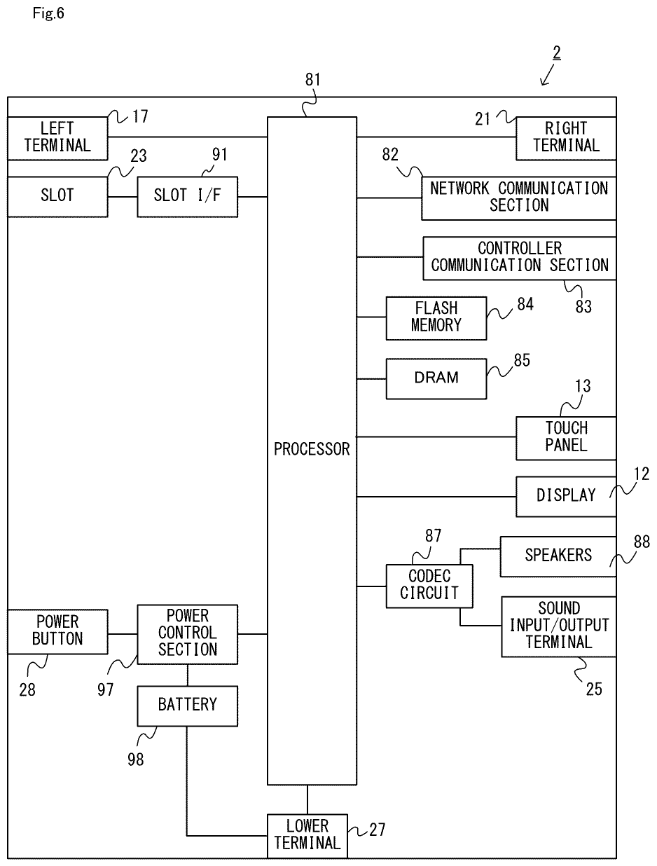

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

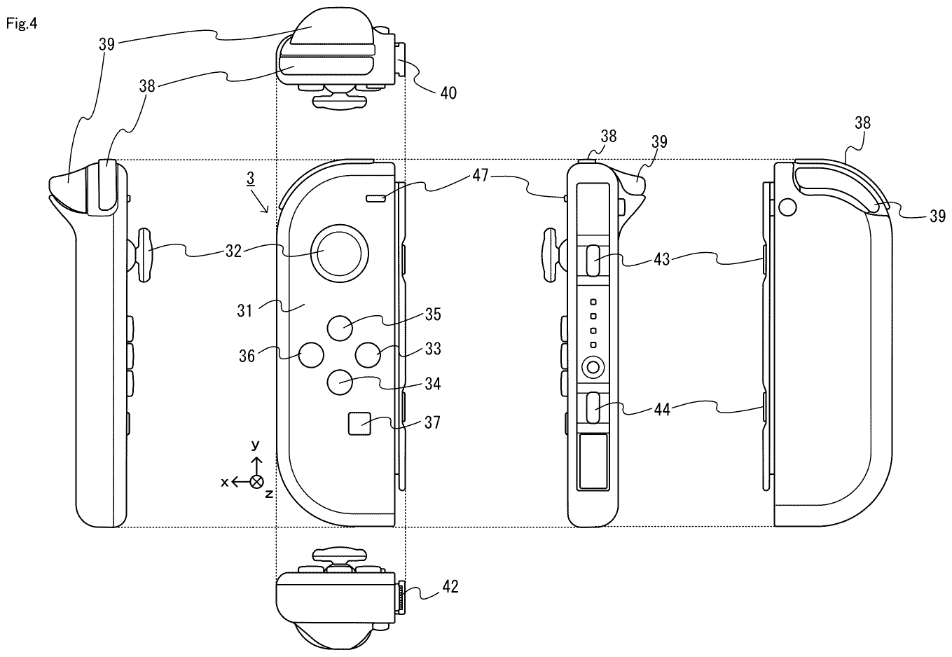

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

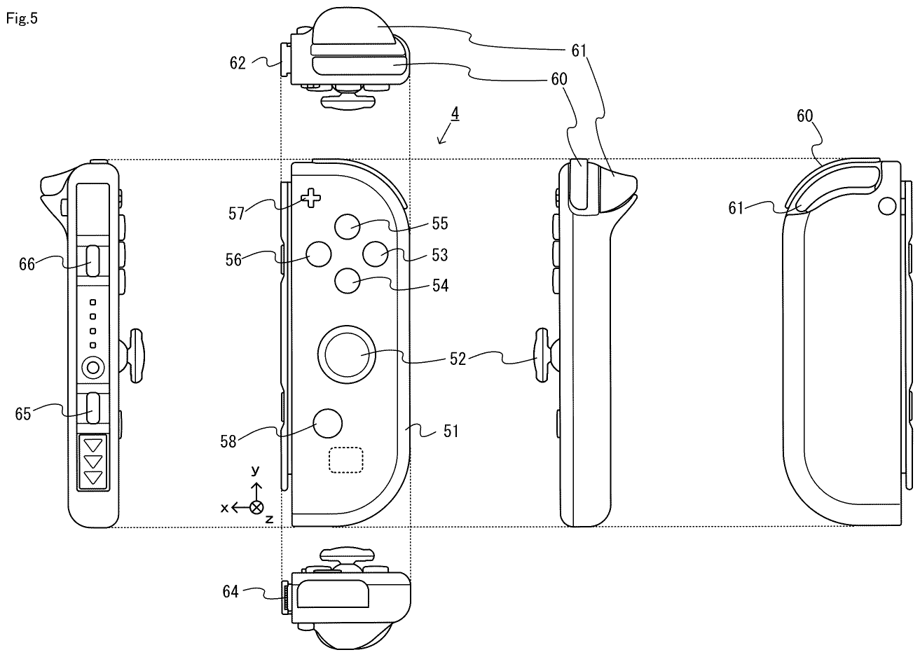

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage. For example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

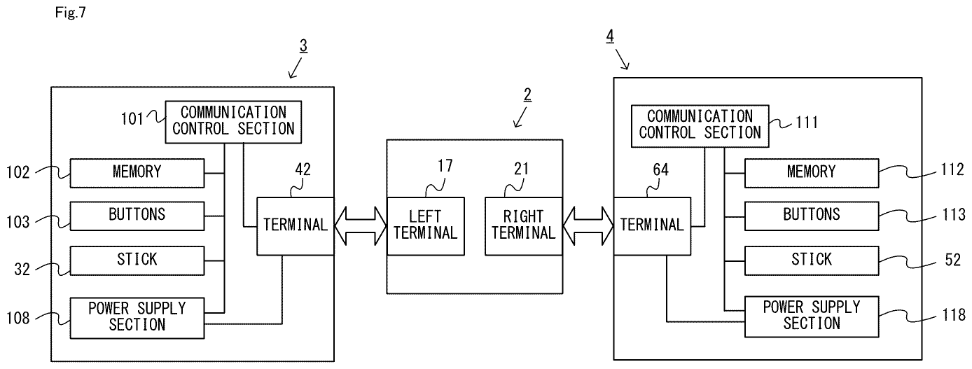

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Outline of Process on Game System

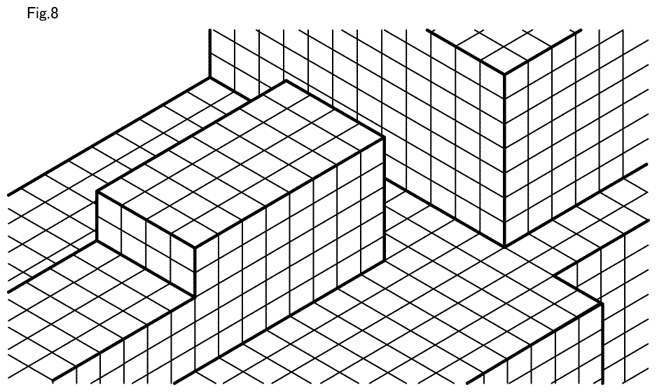

Next, referring to FIG. 8 to FIG. 26, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a stationary monitor.

### [2-1. Voxel]

In the present embodiment, for some objects in the game space, the shape is defined by voxel data. Here, voxels are rectangular parallelepiped (more specifically, cubic) regions arranged in a grid pattern in the game space, and voxel data is data indicating information regarding the voxels. Hereinafter, an object whose shape is defined by voxel data will be referred to as a “voxel object”. In the present embodiment, the game system 1 stores voxel data for a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

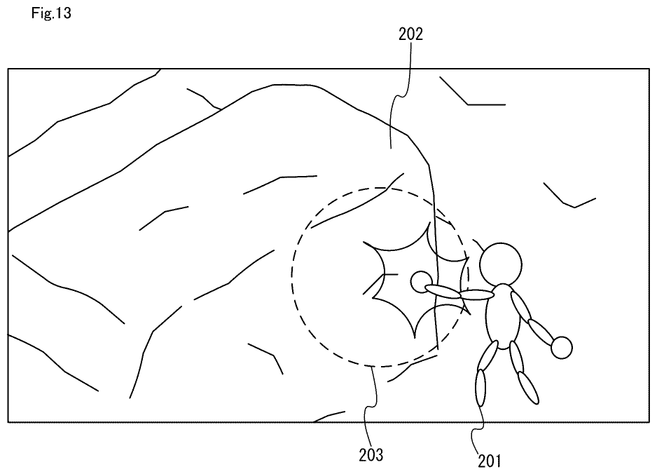

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the present embodiment, in practice, a voxel object is generated (e.g., based on voxel data) by such a rule that results in a terrain object having a complicated shape, such as a terrain object shown in FIG. 13 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 13 based on the object data.

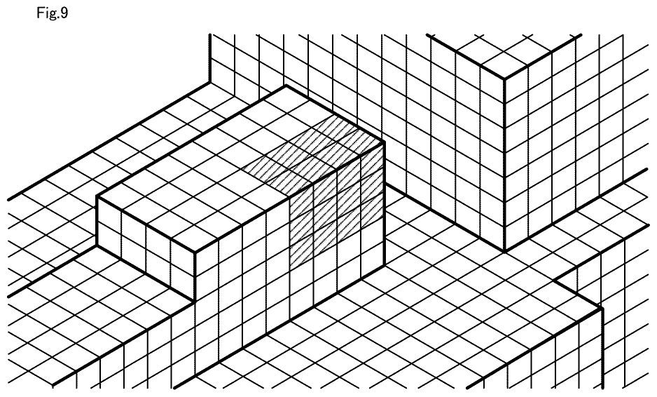

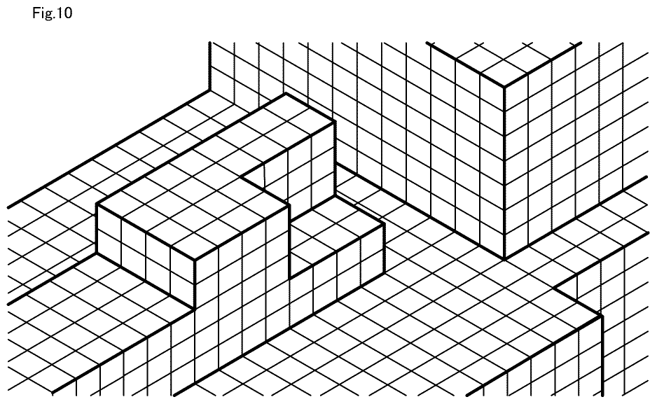

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

In the exemplary embodiment, voxels are defined in the entire game space (e.g., a voxel space in which voxels are set corresponds to the entire game space). However, the voxel space may not necessarily be set over the entire game space, and may be set in a certain area in the game space. If the voxel space is set in a certain area in the game space, the shape of the voxel object is defined by voxel data regarding voxels in the voxel space, and the position of the voxel object in the game space is defined by the position of the voxel space in the game space. The game space may include a main voxel space that is set over the entire game space, and a sub voxel space that is set in a certain area in the game space. In this case, the game system 1 stores therein the voxel data for each voxel space.

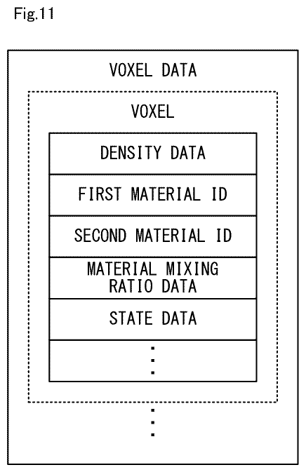

FIG. 11 shows an example of voxel data. The voxel data includes density data, a first material ID, a second material ID, material mixing ratio data, and state data, for each voxel defined in the game space. In the voxel data according to the exemplary embodiment, these pieces of data are set for each voxel.

The density data indicates a density that is an index used for defining the shape of a voxel object based on the voxel (specifically, the shape defined by a mesh described below). As will be described in detail below, the position and shape of the surface of the voxel object (e.g., the mesh described below) are determined based on the density.

In the exemplary embodiment, the density can take an integer value in a range from a lower limit value (e.g., 0) to an upper limit value (e.g., 255). In the exemplary embodiment, the game system 1 determines a surface shape of the voxel object, based on the density such that the proportion of the volume that the area in the voxel object occupies in the voxel tends to be greater when the density value set for the voxel is higher, and the proportion tends to be smaller when the density value is lower. Thus, the density is an index that has an influence on the proportion of the volume that the area in the voxel object occupies in the voxel. The density can also be regarded as an index that indicates the degree of virtual occupation of the content (e.g., the virtual content of the voxel object) in the space of the voxel. For example, when the density is 0, the voxel is empty. When the density is 255, the entire space in the voxel is the content of the voxel object. When the density is a value between 0 and 255, the content of the voxel object occupies the space in the voxel based on (e.g., in a proportion according to) the value. The shape of the mesh, e.g., the surface shape of the voxel object, can be determined based on the density. The mesh can be regarded as the surface of a part, of a voxel, in which the content exists, or as a boundary between a part, of a voxel, in which the content exists and a part, of the voxel, in which the content does not exist. The volume that the area in the voxel object generated based on the density occupies may not necessarily be the volume that exactly matches the proportion indicated by the density. For example, the volume of the voxel object may differ between the method for generating a voxel object as shown in FIG. 8 and the method for generating a voxel object as shown in FIG. 13 even if these methods are based on the same density.

In other embodiments, the density may indicate either a state in which the volume of the area in the voxel object occupies the entire area in the voxel or a state in which the volume of the area in the voxel object is not included in the area in the voxel. For example, the density data may be data that can take only 0 or 1. In other embodiments, the density may be an index indicating that the greater the value of the density is, the smaller the degree of occupation of the content in the space defined by the voxel is.

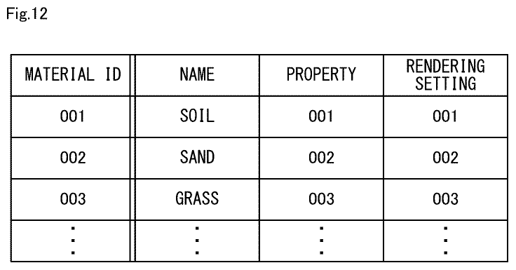

The first material ID and the second material ID are information indicating materials of the corresponding voxel. In the exemplary embodiment, a material such as sand, rock, or soil is set for a voxel. In the game system 1, multiple types of materials are prepared as materials that can be set for voxels (see material data shown in FIG. 12). In the exemplary embodiment, at most two materials out of the prepared multiple types of materials can be set for one voxel. The first material ID is an ID indicating a first material set for the voxel, and the second material ID is an ID indicating a second material set for the voxel. As will be described in detail below, a material of a voxel object (e.g., a material to be set for a polygon of the voxel object) is determined based on the materials set for voxels.

As described above, in the exemplary embodiment, the voxel data includes the ID indicating the material. However, in other embodiments, the voxel data may have a data structure that includes data directly indicating the details of the material (e.g., information on the name, property, and rendering setting described below).

The material mixing ratio data is an example of data indicating a ratio of materials in the voxel. In the exemplary embodiment, since at most two material IDs are set for one voxel, the material mixing ratio data, which indicates the ratio of one of the material indicated by the first material ID and the material indicated by the second material ID, can also indicate the ratio of the other material. In the exemplary embodiment, it is assumed that the material mixing ratio is a value indicating the ratio of the second material to the entire material consisting of the first material and the second material. The value is 0 or more and 1 or less. For example, if the material mixing ratio set for a certain voxel is 0.4, this indicates that the voxel is composed of the first material and the second material in the ratio of 0.6:0.4. As will be described in detail below, the appearance and property of the voxel object are determined based on the materials. The material mixing ratio is used to determine the appearance and property of the voxel object. In other embodiments, the material mixing ratio may be a value indicating the proportion of the first material. The ratio of the materials in the voxel may be indicated by the values of the proportions of the materials. In particular, in other embodiments, if the number of settable types of materials is not limited to two at most and three or more types of materials can be set, the ratio of the materials in the voxel is indicated by a plurality of values respectively indicating the proportions of the materials.

In the exemplary embodiment, two types of materials may not necessarily be set for a voxel, and one type of material may be set. For example, if one type of material is set for a certain voxel, the first material ID indicates this material, and the material mixing ratio is set at 0.

The state data indicates a state that is set for the corresponding voxel. The specific content of state data and the number of types thereof are discretionary. In the exemplary embodiment, the state data includes data indicating the amount of damage set on the voxel. In other embodiments, the state data may include data indicating whether or not the voxel is wet (and its extent), for example.

As described above, in the exemplary embodiment, since the voxel data includes the material ID, the game system 1 stores therein material data that defines the content of the material indicated by the material ID. FIG. 12 shows an example of the material data. As shown in FIG. 12, in the material data according to the exemplary embodiment, for each material, a material ID is associated with information on a name, a property, and rendering setting that are set for the material.

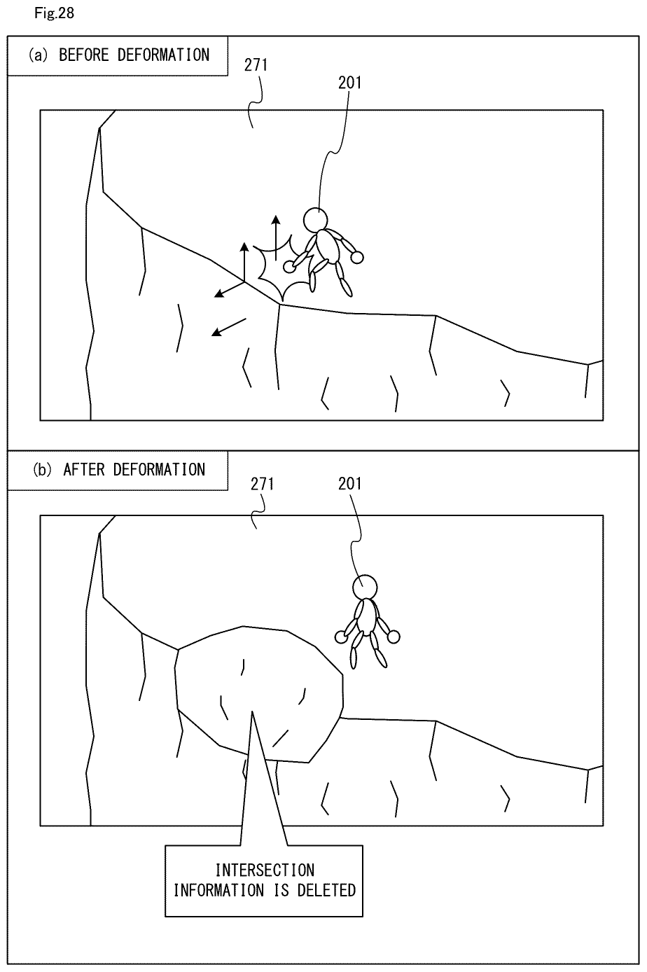

The name included in the material data is a name (e.g., soil, sand, grass, etc.) set for the material. As will be described in detail below, during the game, the name of the material of the voxel object may sometimes be displayed (see FIG. 28). In order to perform such a display, the material data includes information on the name of the material.

The property included in the material data is a property set for the material. The property of the material is a property that the voxel object, on which the material is set, possesses in the game. The specific content of the property of the material, and the number of types of properties are discretionary. For example, at least one of the following pieces of information may be set as properties of a material.
Hardness
Weight
Slipperiness
Damage setting in the case where the player character comes into contact with the voxel object
Temperature
Whether another object can be bonded to the voxel object
Amount of hit points to be regained by the player character when the player character destroys or acquires the voxel object
Amount of in-game currency to be gained by the player character when the player character destroys or acquires a voxel object

In other embodiments, information different from those listed above may be set as information indicating a property of a material.

In the exemplary embodiment, the material data includes, as information that identifies a property of a material, an ID indicating the property (see FIG. 12). Although not shown in FIG. 12, the game system 1 stores, for each property to be prepared, property information in which the property ID is associated with the content of the property (e.g., a value indicating the aforementioned weight or slipperiness). By referring to the property information, the game system 1 can specify the specific content of the property set for the material.

The rendering setting included in the material data is information that indicates setting regarding rendering, such as a texture used for rendering of the voxel object for which the material is set. In the exemplary embodiment, the material data includes, as information on rendering setting, an ID of a texture to be used for rendering the voxel object for which the material is set (see FIG. 12). Although not shown in FIG. 12, the game system 1 stores, for each texture prepared, texture information in which the texture ID is associated with the texture indicated by the texture ID. By referring to the texture information, the game system 1 can specify the specific content of the texture set for the material. In other embodiments, as information on rendering setting, any information regarding setting of shading may be set in addition to the texture information. For example, information regarding reflectivity, normal, or the like may be set.

The material data may include data other than the data shown in FIG. 13. For example, the material data may include data regarding sound setting. For example, the data regarding the sound setting may be data that defines the sound of footsteps that is outputted when the player character walks on the voxel object based on the voxel.

The material data may be data of any form capable of specifying the property and/or rendering setting of the material. For example, in other embodiments, the material data may have a data structure including data that directly indicates the property and/or rendering setting of the material, instead of the data structure including the material ID and the texture ID.

### [2-2. Update of Voxel Data]

During the game, the voxel object is deformed when the voxel data is updated. In the exemplary embodiment, when a game event for updating the voxel object (hereinafter referred to as “update event”) has occurred, the game system 1 updates the voxel data. The update event may have any content. For example, the update event may be that a character that appears in the game has performed an action to deform the voxel object (e.g., the player character has punched the voxel object), or may be that an event that deforms the voxel object has occurred (e.g., contact of an object thrown by a character with the voxel object, or explosion of a bomb).

FIG. 13 shows an example of a game space when an update event has occurred. In the situation shown in FIG. 13, a player character 201 has performed a punching action to a terrain object 202 that is a voxel object. As will be described in detail below, in the example shown in FIG. 13, the voxel data is updated such that the terrain object 202 at and around a position hit by the punching action of the player character 201 is deleted. This represents how the terrain object 202 is destroyed by the punching action of the player character 201.

In the exemplary embodiment, when such an update event has occurred, the game system 1 sets, in the game space, an update range in which the voxel object is updated (in the example shown in FIG. 13, an update range 203). The position, shape, and size of the update range are discretionary. The position of the update range may be determined based on, for example, a position at which an object regarding the generated update event (e.g., the player character that has punched) comes into contact with the voxel object. In the example shown in FIG. 13, the position of the update range 203 may be determined based on a position that is hit by the punch of the player character 201. For example, the hit position, or a position a predetermined distance ahead of the hit position may be a center position of the update range 203. The shape and size of the update range may be determined in advance according to the type of the update event. For example, when an update event due to a punch of the player character 201 has occurred, the shape and size of the update range may be determined to be a sphere having a predetermined size as shown in FIG. 13. The size of the update range may be determined based on a value indicating the degree of influence of the generated update event (e.g., the intensity of the punch, or the magnitude of the explosion).

The game system 1 changes the density of a voxel corresponding to the set update range. The voxel corresponding to the update range is, for example, a voxel within the update range or a voxels overlapping the update range. As a result of the change in the density, the mesh of the voxel object is changed by a process described below, thereby changing the shape of the voxel object (the shape by appearance, and the shape used for contact determination). In other embodiments, in addition to changing the density of the voxel included in the update range, the game system 1 may change the material in the voxel (e.g., the first material, the second material, and the material mixing ratio), or may change the state in the voxel.

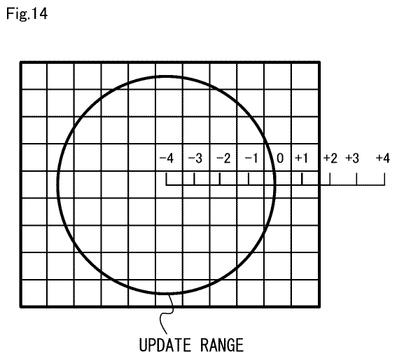

In the exemplary embodiment, the game system 1 determines whether or not a voxel is included in the update range, by using an SDF (Signed Distance Field). The game system 1 sets an SDF indicating an update range set in the game space, and performs the aforementioned determination based on the value of the SDF. The SDF represents distances, with signs, of any positions from a shape that the SDF defines. FIG. 14 shows an example of the update range. In the example shown in FIG. 14, a spherical update range is set in the game space. For example, in the example shown in FIG. 14, an SDF is set such that, among positions in the game space, positions inside the shape represented by the SDF have negative SDF values, and positions outside the shape represented by the SDF have positive SDF values. In this example, whether or not each position is included in the update range can be determined depending on whether or not the SDF value is positive or negative. In addition, using the SDF values allows not only simple inside/outside determination but also a process such as correction or interpolation.

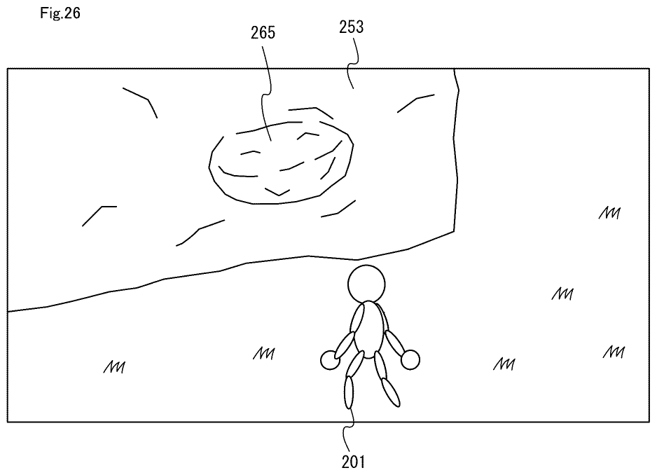

In the example described above, a change in which the voxel object in the update range is deformed as if it is deleted, is applied to the voxel object. However, a change to be applied to the voxel object by using the update range is not limited thereto. For example, a change in which a voxel object is newly added in the update range (e.g., the volume that an area in the voxel object occupies is increased by the update range) may be applied to the voxel object (see FIG. 26 described below). A change in which only the voxel material in the update range is changed while the voxel density is not changed, may be applied to the voxel object. A change in the voxel density and a change in the voxel material may be integrally applied.

### [2-3. Calculation of Vertices]

When the voxel density has been updated as described above, the game system 1 sets vertices based on the updated voxel data. The vertices can be vertices of a mesh of a voxel object. As will be described in detail below, in the exemplary embodiment, the vertices are simplified, and the simplified vertices become the vertices of the mesh of the voxel object.

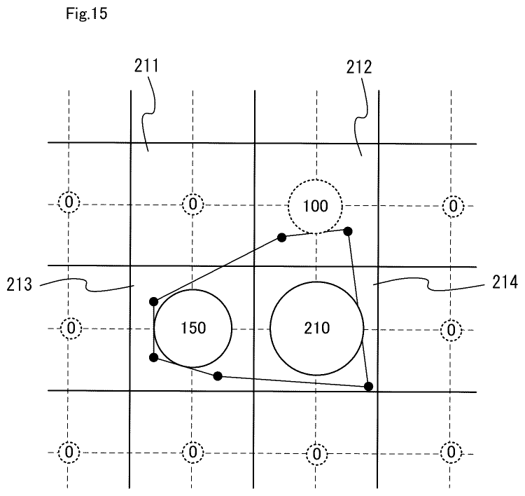

FIG. 15 shows an example of a method for setting vertices. In FIGS. 15 to 17, and 19 to 24, voxels, vertices, meshes, etc., are represented in two dimensions for the purpose of making the drawings easily viewable, and the description easily understandable. However, in actuality, vertices and meshes are set in a three-dimensional space, based on voxels in the three-dimensional space. In the exemplary embodiment, the game system 1 executes a method in which, for a portion where a voxel having a density that is set to a value indicating “existence” (e.g., a density equal to or greater than a reference value described below) is adjacent to a voxel having a density that is set to a value indicating “nonexistence” (e.g., a density less than the reference value described below), a vertex is set at coordinates based on the positions and densities of a plurality of neighboring voxels around the portion. Hereinafter, this method will be described in detail.

As described above, in the exemplary embodiment, the density set for a voxel is in the range of 0 to 255. A voxel having a density of 0 is completely empty, and a voxel having a density of 255 is completely filled up. Densities between 0 and 255 are complementarily treated, and are used for determining a vertex. In the exemplary embodiment, voxels are virtually treated such that voxels whose densities are equal to or greater than a reference value are inside a voxel object, and voxels whose densities are less than the reference value are outside the voxel object. It is also possible to virtually treat voxels such that voxels whose densities are equal to or greater than the reference value are voxels indicating “existence”, and voxels whose densities are less than the reference value are voxels indicating “nonexistence”. It is not necessary to define only voxels having a density of 0 as being outside the voxel object (e.g., reference value=1), and the reference value may be set to, for example, 128. In the example shown in FIG. 15, a voxel 211 and the other outer voxels have a density of 0, a voxel 212 has a density of 100 which is less than the reference value (e.g., 128), and voxels 213, 214 respectively have densities of 150, 210 which are greater than the reference value. In the exemplary embodiment, the game system 1 generates vertices between the voxels whose densities are equal to or greater than the reference value and the voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. The coordinates of each vertex are determined by comparing the densities of adjacent voxels and performing interpolation based on the difference in density for each of the XYZ axes. Normal information that defines positions and directions of straight lines connecting the vertices may be set in advance, whereby the coordinates of each vertex can be calculated based on the normal information. The normal information may be stored in advance for at least some of the voxels, or if not stored, the normal information may also be calculated based on the densities between adjacent voxels. In FIG. 15, since the density of the voxel 212 is less than the reference value, the voxel 212 is treated as being outside the voxel object in the determination of presence/absence of a vertex, but the density value itself of the voxel 212 is used to calculate the coordinates of the vertices to be generated. If the reference value is set to a value lower than the density of the voxel 212, it would result in an increase in the vertices on the upper right side and the upper left side in the voxel 212 shown in FIG. 15.

By setting the vertices as described above, it is possible to generate a shape whose volume is based on (e.g., reflects) the density of each voxel to some extent, in generating a mesh connecting the set vertices (or vertices obtained by subjecting the set vertices to a simplification process described below). However, depending on the relationship with the neighboring voxels, a voxel having a density of 0 may partially include a region inside the voxel object, or a voxel having a density of 255 may partially include a region outside the voxel object. In the exemplary embodiment, since voxels having densities less than the reference value are treated as being outside the voxel object, there are fewer vertices as compared with a case where those voxels are treated as being inside the voxel object, and the volume will be smaller accordingly. That is, there is no need to calculate the polygon mesh so that the volume strictly corresponds to the density value.

Note that calculation of vertices may use intersection information. The intersection information indicates a three-dimensional position and direction in a space where a voxel is set. As will be described in detail below, when such intersection information is set, vertices are set such that a polygonal plane formed by a plurality of vertices ideally includes the position indicated by the intersection information and is perpendicular to the direction indicated by the intersection information. The “polygonal plane formed by a plurality of vertices” is a plane that becomes a plane of a mesh of a voxel object when simplification described below is not performed for the vertices. By setting the intersection information, the shape of the mesh of the voxel object can be defined in more detail. Hereinafter, for convenience, the coordinates of the position indicated by the intersection information are referred to as “intersection coordinates”, and the direction indicated by the intersection information is referred to as “normal direction”. However, as described below, the plane formed by determined vertices may not include the position of the intersection coordinates, or may not be perpendicular to the normal direction.

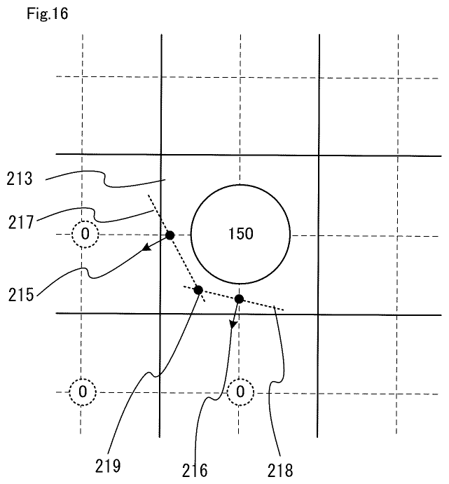

FIG. 16 is a view showing an example of a method for determining vertices in the case where intersection information is set. FIG. 16 shows an example in which intersection information is set for the voxel 213 shown in FIG. 15. As shown in FIG. 16, intersection coordinates indicated by the intersection information are set on a line connecting voxels, more specifically, for example, on a line connecting the center of a voxel and the center of a voxel adjacent to the voxel. A normal direction indicated by the intersection information is a direction at the position of the intersection coordinates. As shown in FIG. 16, the intersection coordinates and the normal direction indicated by the intersection information can be represented as a vector that starts from the position of the intersection coordinates and extends in the normal direction.

Note that intersection information may not necessarily be set for all voxels, and may be set for some of the voxels in the voxel space. For example, intersection information is set for a voxel around which vertices are set. More specifically, when there exists a voxel with a density equal to or greater than the aforementioned reference value and a voxel, adjacent to this voxel, with a density less than the reference value, intersection information is set for either of these voxels. In this case, intersection coordinates are set on a line connecting the center of the voxel with the density equal to or greater than the reference value and the center of the voxel with the density less than the reference value.

When such intersection information is set, vertices are set such that a polygonal plane formed by a plurality of vertices ideally includes the position of the intersection coordinates and is perpendicular to the normal direction. In the example shown in FIG. 16, two pieces of intersection information represented as a vector 215 and a vector 216 are set for the voxel 213. In this case, a vertex 219 is set at a position on a plane 217 defined by the first intersection information represented as the vector 215 and on a plane 218 defined by the second intersection information represented as the vector 216. The “plane defined by intersection information” is a plane that passes through the position of intersection coordinates indicated by the intersection information and is perpendicular to the normal direction indicated by the intersection information. Since the example shown in FIG. 16 is two-dimensional, the elements defined by the intersection information are represented as lines. However, since the voxel space is three-dimensional, in actuality, planes are defined by the intersection information.

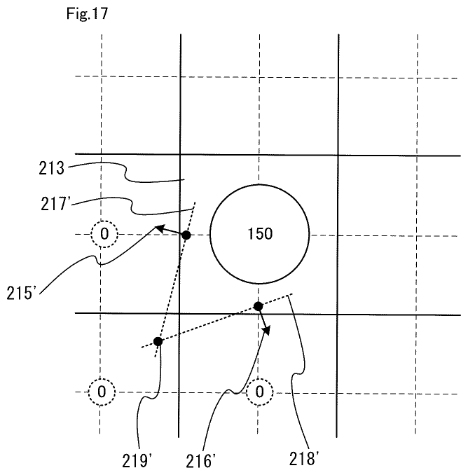

FIG. 17 is a view showing an example of a method for determining vertices in the case where intersection information different from that shown in FIG. 16 is set. In the example shown in FIG. 17, two pieces of intersection information represented as vectors 215′ and 216′, different from the vectors 215 and 216 shown in FIG. 16, are set for the voxel 213. In this case, a vertex 219′ is set at a position on a plane 217′ defined by the first intersection information represented as the vector 215′ and on a plane 218′ defined by the second intersection information represented as the vector 216′. The vertex 219′ shown in FIG. 17 is set at a position farther from the center of the voxel 213 than the vertex 219 shown in FIG. 16, and the angle of the vertex 219′ is smaller than the angle of the vertex 219. In the example shown in FIG. 17, the mesh of the voxel object has a sharper shape than the example shown in FIG. 16 at the position of the vertex 219′.

As shown in FIG. 16 and FIG. 17, by setting intersection information, it is possible to generate meshes of voxel objects so as to have different shapes even if the same density is set for the voxels. In a method for determining vertices based on the densities without using intersection information, it is sometimes difficult to define the detailed shape of a mesh as intended by the developer. In the above method, for example, it is difficult to make a corner of a mesh of a voxel object have a sharp shape, or to make a corner of a mesh of a cuboidal voxel object be a corner where three planes are perpendicular to each other. In contrast, by setting intersection information and determining vertices using the intersection information, it becomes easier to define the shape of a mesh in more detail, making it easier to achieve the intended shape.

If a plurality of pieces of intersection information are set, it may be impossible to set vertices so as to satisfy all conditions based on the respective pieces of intersection information. In other words, it may be impossible to set vertices such that a polygonal plane formed by a plurality of vertices includes the positions of the intersection coordinates indicated by the intersection information and is perpendicular to the normal directions indicated by the intersection information. Therefore, in the exemplary embodiment, the game system 1 sets a vertex such that an error between a plane defined by intersection information and the vertex is minimized. Thus, a plane of a mesh generated based on the set vertex is arranged facing the normal direction at the position of intersection coordinates, or is arranged such that an error from the arrangement is minimized. The specific method for determining a vertex is discretionary. For example, the game system 1 sets a vertex such that the sum of the squared distances between a plane defined by intersection information and the vertex is minimized. The vertex may be set within a predetermined range based on the position of the voxel for which intersection information is set. In this case, a vertex may be set at a position where an error is minimized within the predetermined range. The predetermined range is, for example, the range of a vertex division region described below, including the center of the voxel for which intersection information is set (in the example shown in FIG. 16, a square range shown by broken lines).

When vertices are determined using intersection information, the game system 1 may determine, for a voxel for which intersection information is not set, vertices based on intersection coordinates and normal direction that are set based on the density of the voxel. In other words, the game system 1 may set, based on the density, intersection coordinates and normal direction similar to those indicated by intersection information, and may determine vertices using the set intersection coordinates and normal direction in a manner similar to the vertex determination method based on intersection information set for the voxel. The method for setting intersection coordinates and normal direction based on density is discretionary. The intersection coordinates and normal direction may be calculated based on the densities of two voxels, the centers of which are located at both ends of a line on which the intersection coordinates are set. For example, the game system 1 may calculate the value of density at each position on the line connecting the centers of the two voxels by interpolating the densities of the voxels, and may determine, as the position of intersection coordinates, the position where the density is an intermediate value (e.g., 127.5) in the range of possible density values. Also, for example, the game system 1 may calculate a density slope based on the densities set for the voxel and neighboring voxels, and use the slope as the normal direction. In the exemplary embodiment, both the intersection coordinates and the normal direction are calculated based on the densities set for the voxels. In other embodiments, the game system 1 may calculate only the intersection coordinates based on the densities, and determine vertices using the calculated intersection coordinates and intersection information.

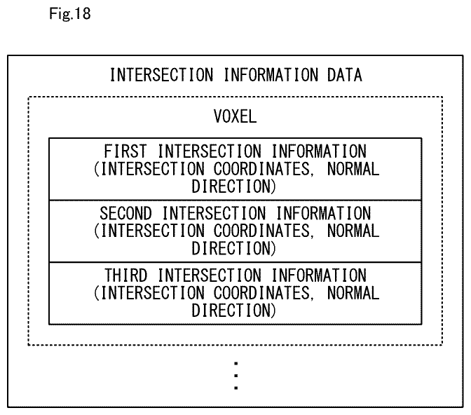

The game system 1 stores therein intersection information data indicating intersection information to be set. FIG. 18 is a view showing an example of the intersection information data. In the exemplary embodiment, the intersection information data is data indicating intersection information to be set for each voxel. Intersection information is associated with any of voxels in the game space. For example, information (e.g., coordinate information) indicating a position in a grid that is set at the same position and with the same size as a grid of a voxel in the game space is associated with the intersection information, whereby the intersection information may be associated with one voxel in the game space. As described above, intersection information may be set for some voxels, and there may be voxels for which intersection information is not set.

In the exemplary embodiment, for one voxel, pieces of intersection information set in three directions from the voxel are associated with this voxel (see FIG. 18). Specifically, when axes extending in three directions in which voxels are lined up in the game space are xyz axes, the voxel is associated with first intersection information set on a line extending to the x-axis positive side from the center of the voxel, second intersection information set on a line extending to the y-axis positive side from the center of the voxel, and third intersection information set on a line extending to the z-axis positive side from the center of the voxel. One voxel may not necessarily be associated with the three pieces of (first to third) intersection information, and may be associated with one or two pieces of intersection information. One piece of intersection information includes information on intersection coordinates and normal direction. Intersection information may be information in any format. For example, intersection information may include: information indicating three-dimensional coordinates that represent the intersection coordinates; and information indicating three vectors obtained when the normal direction is expressed as components regarding predetermined three axial directions. In order to further reduce the amount of data, information indicating the normal direction may be composed of: information on two vectors regarding two axial directions out of the three axial directions; and information on a value indicating the direction (positive direction or negative direction) regarding the remaining one axial direction.

As described above, in the exemplary embodiment, the game system 1 stores therein intersection information data separately from voxel data. In other embodiments, intersection information data may be stored as part of voxel data. For example, voxel data may include intersection information data indicating three pieces of intersection information associated with the corresponding voxel.

The game system 1 determines a material for each of the vertices set as described above. The material of the vertex is determined based on materials regarding voxels around this vertex. The voxels around the vertex are, for example, voxels used for determining whether or not to generate the vertex (e.g., voxels overlapping the aforementioned region that straddles voxels). The method for determining a material for a vertex is discretionary. For example, in the exemplary embodiment, the game system 1 selects a predetermined number (e.g., at most two types) of materials out of the materials set for the neighboring voxels, and determines the selected materials as materials for the vertex.

### [2-4. Simplification of Vertices]

In the exemplary embodiment, the game system 1 simplifies the vertices calculated as described above. That is, the game system 1 replaces some of the vertices calculated as described above with one vertex to decrease the number of vertices. As will be described in detail below, the coordinates (e.g., position) and the material of the replacing vertex are set based on a plurality of vertices before replacement. Such simplification can reduce the numbers of vertices and polygons that form a mesh of a voxel object, thereby reducing the amount of memory used for processing, and reducing the processing load.

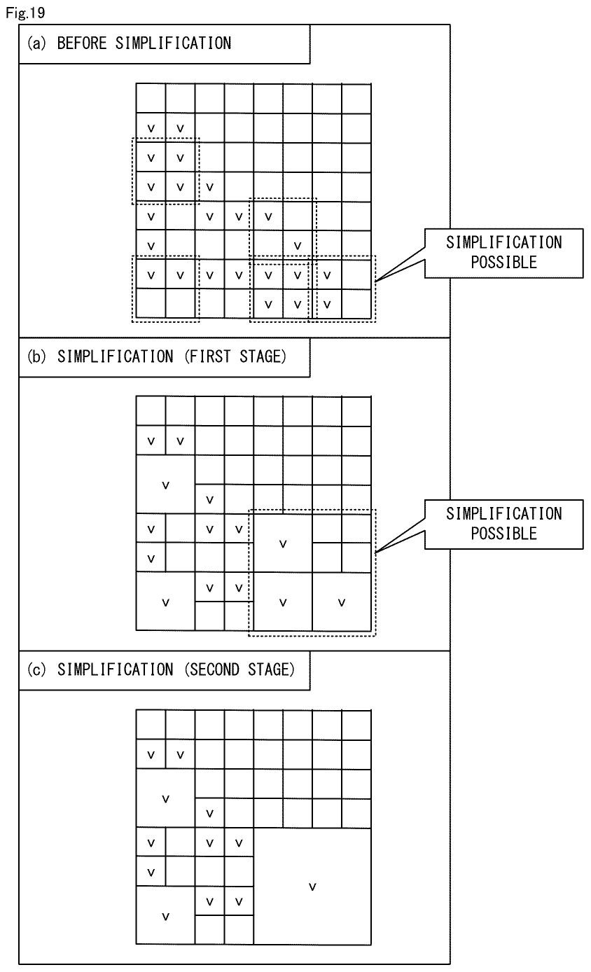

In the exemplary embodiment, the game system 1 performs simplification by representing vertices using SVO (Sparse Voxel Octree). FIG. 19 shows an example of vertex simplification. In FIG. 19, one square delimited by solid lines in (a) represents one vertex division region. Here, the vertex division region is a square region with a center position of a voxel being a vertex (in an actual three-dimensional space, the vertex division region is a cube or a rectangular parallelepiped), and corresponds to a region with the dotted lines being sides shown in FIG. 15 to 17. In FIG. 19, each vertex division region having a character “v” inside is a vertex division region in which a vertex is set.

In the exemplary embodiment, the game system 1 determines whether or not simplification can be performed with respect to the vertices in a predetermined number of (four in FIG. 17, and eight in an actual three-dimensional space) vertex division regions adjacent to each other. If the determination result is that simplification can be performed, simplification is performed for the vertices in the predetermined number of vertex division regions.

In FIG. 19, (a) shows the state before simplification is performed. In the example shown in FIG. 19, it is determined that simplification can be performed for vertex division regions within a range surrounded by dotted lines. In this case, the game system 1 performs simplification such that the vertices in the predetermined number of vertex division regions determined to be simplified are replaced with one vertex (see (b) of FIG. 19). Thus, the vertices in the predetermined number of vertex division regions are simplified to one vertex.

In the exemplary embodiment, the game system 1 performs simplification in a plurality of stages. The number of the stages is discretionary. In FIG. 19, first and second stages are shown and described. In FIG. 19, (b) shows the state in which the first-stage simplification has been performed, and (c) shows the state in which the second-stage simplification has been performed. In the second-stage simplification, whether or not simplification can be performed is determined for vertices that are generated by the first-stage simplification. In the example shown in FIG. 19, when the determination result is that the vertex division regions within a range surrounded by dotted lines in (b) of FIG. 19 can be subjected to simplification, the vertices in the vertex division regions are simplified, resulting in the state shown in (c) of FIG. 19. The condition for determining whether or not the first-stage simplification can be performed and the condition for determining whether or not the second-stage simplification can be performed may be the same or different from each other.

The specific method for determining whether or not simplification can be performed is discretionary. In the exemplary embodiment, as conditions for the above determination, a condition regarding the shape of the voxel object and a condition regarding the material of the voxel object are used. In the exemplary embodiment, if both the condition regarding the shape of the voxel object and the condition regarding the material of the voxel object are satisfied, it is determined that simplification can be performed. If at least one of the condition regarding the shape of the voxel object and the condition regarding the material of the voxel object is not satisfied, it is determined that simplification cannot be performed.

The condition regarding the shape is, for example, that there is no significant change between the shape due to the vertices before the simplification and the shape due to the vertices after the simplification. For example, determination as to whether or not there is a significant change in the shape due to the vertices before and after the simplification may be performed by calculating an index indicating an error between the mesh before the simplification and the mesh after the simplification, and determining whether or not the index is equal to or smaller than a predetermined allowable value. Furthermore, for example, if the shape due to the vertices after the simplification is not a hollow shape while the shape due to the vertices before the simplification is a hollow shape (e.g., the simplification causes missing of information that the shape is hollow), it is determined that the condition regarding the shape is not satisfied. Whether or not the aforementioned case will occur can be determined based on, for example, the densities of voxels corresponding to the vertex division regions to be subjected to the determination. Moreover, for example, if the shape due to the vertices before the simplification can be represented only by two or more vertices, e.g. it cannot be represented by one vertex, it is determined that the condition regarding the shape is not satisfied. As the condition regarding the shape of the voxel object, the same condition as that used for the conventional method with the SVO may be used.

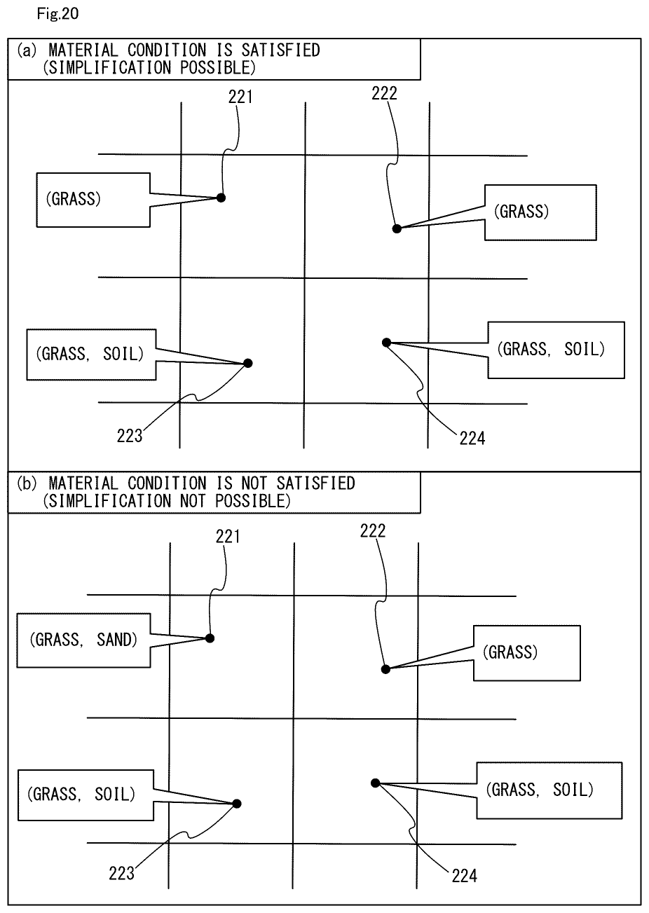

In the exemplary embodiment, as the condition regarding the material, a condition regarding the number of types of materials to be set for the vertices in the predetermined number of vertex division regions to be subjected to simplification, is used. FIG. 20 shows an example of the condition regarding the material. In FIG. 20, (a) shows a case where the materials of vertices 221 to 224 are “grass”, “grass”, “grass and soil”, and “grass and soil”, respectively, and (b) shows a case where the materials of the vertices 221 to 224 are “grass and sand”, “grass”, “grass and soil”, and “grass and soil”, respectively. In the exemplary embodiment, the condition regarding the material is that the total number of the types of materials set for the vertices to be subjected to simplification is equal to or less than a predetermined number. For example, the condition regarding the material is that the total number is equal to or less than the number of materials that can be set for one vertex. In the exemplary embodiment, the predetermined number is 2. For example, in the case of (a) of FIG. 20, since the total number of the types of materials set for the vertices 221 to 224 to be subjected to simplification is 2 (e.g., grass and soil), the condition regarding the material is satisfied. In this case, it is determined that the vertices 221 to 224 can be subjected to simplification on the condition that the aforementioned condition regarding the shape of the object is satisfied. On the other hand, in the case of (b) of FIG. 20, since the total number of the types of materials set for the vertices 221 to 224 to be subjected to simplification is 3 (e.g., grass, soil, and sand), the condition regarding the material is not satisfied. In this case, it is determined that the vertices 221 to 224 cannot be subjected to simplification regardless of whether or not the condition regarding the shape of the object is satisfied.

In the game system 1, multiple types of materials to which the same property is set and which are different in appearance may be prepared even though these materials should strictly be classified into different types. Some of the multiple types of materials may be regarded as being of the same type in determining whether the condition regarding the material is satisfied. For example, multiple types of soil materials having the same property and similar appearances (e.g., texture colors or patterns) may be prepared. In this case, the game system 1 may determine whether the condition regarding the material is satisfied while regarding the multiple types of soils as being of the same type.

In the exemplary embodiment, at most two types of materials can be set for a vertex as in the case of a voxel. Meanwhile, in the exemplary embodiment, if the total number of the types of materials set for the vertices to be subjected to simplification is three or more, simplification is not performed. That is, if the total number of the types of materials exceeds the number of materials that can be set for one vertex, simplification is not performed. Therefore, even when the number of vertices is reduced through simplification, the simplification does not cause missing of information on the materials set for the vertices, thereby maintaining the information on the materials.

In the exemplary embodiment, a material of the vertex after the simplification is determined based on the materials of the vertices before the simplification. Specifically, the game system 1 sets the one or two types of materials set on the vertices before the simplification, as the first material and the second material of the vertex after the simplification. This allows the information on the materials to be maintained. The ratio of the materials after the simplification is determined based on the ratio of the materials of the vertices before the simplification.

### [2-5. Generation of Mesh]

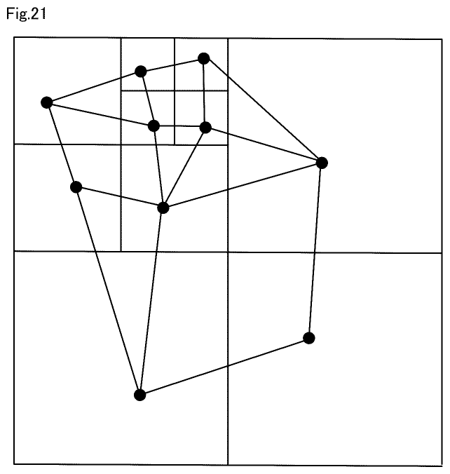

In the exemplary embodiment, a mesh of a voxel object is generated based on vertices having been simplified as described above. FIG. 21 shows an example of a mesh generated based on such vertices. Each of squares shown in FIG. 21 represents a vertex division region as described above, or a vertex division region obtained by integrating a plurality of vertex division regions through simplification. As shown in FIG. 21, the game system 1 generates a mesh that is composed of polygonal shapes each having, as one side, a straight line connecting vertices of adjacent vertex division regions. Each of the polygonal shapes forming the mesh is a triangle or a quadrangle.

In the exemplary embodiment, the game system 1 generates two types of meshes - e.g., a display mesh and a determination mesh. The display mesh is a mesh used for displaying a voxel object. The determination mesh is a mesh used for collision determination for a voxel object. As will be described in detail below, by using the two types of meshes, the game system 1 can perform processing with the meshes suitable for display of the voxel object and collision determination, respectively.

In the exemplary embodiment, the game system 1 generates the display mesh and the determination mesh, based on data of the SVO described above (e.g., based on the simplified vertices). Thus, sharing vertex data in generating the two types of meshes improves efficiency of processing. In other embodiments, the game system 1 may not necessarily perform simplification of vertices, and may generate a display mesh and/or a determination mesh, based on vertices that are not simplified.

In the exemplary embodiment, the game system 1 generates the determination mesh so as to be simpler in shape than the display mesh. Specifically, the game system 1 makes the number of vertices of the determination mesh less than the number of vertices of the display mesh. Here, in the exemplary embodiment, the data of the SVO holds, in an octree data structure, data of vertices before simplification and data of simplified vertices, and also includes data used for determining whether or not simplification can be performed. This data includes, for example, data of vertices (referred to as “provisional vertices”) calculated as candidates for a vertex after simplification, and data of the aforementioned index indicating an error between the vertices before simplification and the provisional vertices. For example, the game system 1 may use, among the provisional vertices, a vertex the index of which is equal to or less than a predetermined threshold value (this threshold value is greater than the aforementioned allowable value), for generation of the determination mesh. This allows the number of vertices of the determination mesh to be less than the number of vertices of the display mesh. The number of vertices of the determination mesh being less than the number of vertices of the display mesh allows a reduction in processing load for collision determination. Moreover, since the number of vertices of the display mesh is not excessively reduced, the appearance of the voxel object can be represented in detail.

In other embodiments, the display mesh and the determination mesh may be generated based on the same data, or may be generated based on different data. The display mesh and the determination mesh may have the same shape (even in this case, materials set for these meshes may be different from each other). The number of vertices of the determination mesh may be equal to the number of vertices of the display mesh, or may be greater than the number of vertices of the display mesh.

The game system 1 determines a material for each of polygons of a mesh. A material of a polygon is determined based on a material set for each of vertices of the polygon. The specific method for determining a material of a polygon is discretionary. In the exemplary embodiment, as for a polygon of a display mesh, the game system 1 selects at most two types of materials from among the materials set for the vertices of the polygon, and determines the selected materials as materials of the polygon. As for the polygon of the display mesh, at most two types of materials are set for each of the vertices of the polygon, and the polygon is rendered based on the materials set for each vertex. As for a polygon of a determination mesh, the game system 1 selects one type of material from among the materials set for the vertices of the polygon, and determines the selected material as a material of the polygon.

As described above, in the exemplary embodiment, a display mesh and a determination mesh are set for one voxel object. However, depending on the game situation, both the display mesh and the determination mesh may not necessarily be set for one voxel object at the same time (e.g., both the meshes may not necessarily be set in processing one frame). For example, in the game space, the determination mesh may be generated in a range where collision determination is performed, and may not necessarily be generated in a range where collision determination is not performed. As an example, the game system 1 may generate the determination mesh for voxel objects within a predetermined range around the player character. For voxel objects outside the predetermined range, the game system 1 may generate only the display mesh without generating the determination mesh.

As for the display mesh, the game system 1 may store data regarding the generated mesh in a memory. In frames after generation of the mesh, the game system 1 may use the stored data without executing the mesh generating process again, except for a range where an update is performed. This can decrease the processing load for generating the display mesh. Meanwhile, as for the determination mesh, the game system 1 may not necessarily store data regarding the generated mesh in the memory, and may generate a mesh on an as-needed basis (e.g., each time collision determination is required). This saves memory use for generation of the mesh.

The method for, when voxel data has been changed from its initial state, generating meshes (e.g., a display mesh and a determination mesh) based on the changed voxel data, has been described above. This method can also be used for a case where the meshes are generated based on the voxel data in the initial state when a game is started, for example. However, the meshes based on the voxel data in the initial state may not necessarily be generated based on the voxel data in the initial state when the game is started, and may be prepared in advance of starting the game.

### [2-6. Processing Using Mesh]

Next, an example of processing using a mesh generated for a voxel object as described above will be described. Hereinafter, a description will be given of a case where a terrain object such as the ground or a wall is a voxel object, a player character performs an action, and an in-game behavior is generated as a result of collision determination.

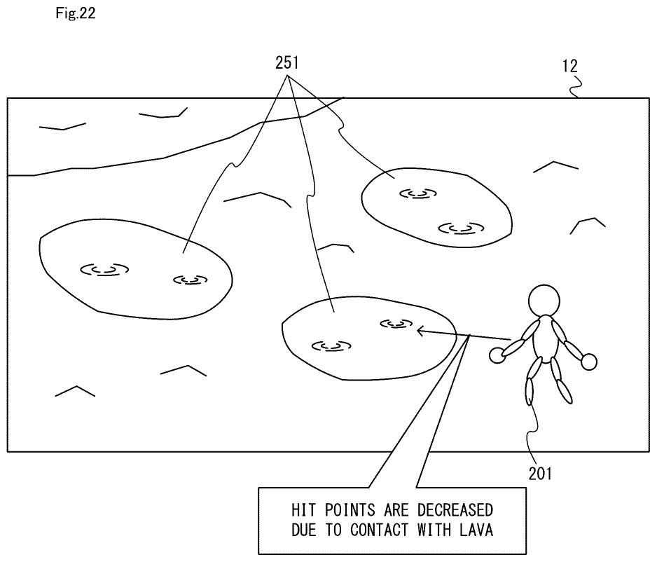

FIG. 22 shows an example of a game image representing a state in which a player character moves on a terrain object. In the example shown in FIG. 22, a material of polygons in partial regions 251 in a determination mesh of the terrain object being the ground is set to “lava”. Meanwhile, a material of polygons other than those in the regions 251 in the determination mesh of the terrain object is set to “rock”. In the example shown in FIG. 22, the game system 1 performs collision determination between the terrain object and the player character 201 by using the determination mesh. That is, the game system 1 performs collision determination as to whether or not the determination mesh of the terrain object comes into contact with a determination region set for the player character (e.g., a region having a predetermined shape that is set based on the position of the player character). When a collision between the polygon whose material is lava and the player character 201 has been determined, a process of reducing the hit points of the player character 201 is performed as a process of generating an in-game behavior. Moreover, in the above case, a process of causing the player character 201 to perform a predetermined reaction is performed.

In the exemplary embodiment, regarding the lava material, a property of reducing the hit points of the player character that has come into contact with the material (e.g., a property of having a temperature equal to or higher than a predetermined value) is set as property information included in the aforementioned material data. The game system 1 generates an in-game behavior (in the above example, reduction in the hit points of the player character) based on the property information corresponding to the material set for the polygon in the determination mesh for which a collision has been determined through the collision determination.

When a collision between a polygon whose material is rock and the player character 201 has been determined, the process of reducing the hit points of the player character is not performed. Based on the collision, the player character 201 is controlled so as not to be able to enter the polygon. Therefore, the player character can stand and walk on the polygon. Thus, in the exemplary embodiment, by setting a material for each polygon, the game system 1 can perform different processes depending on which part of the voxel object another object has come into contact with. In addition, the content of a process to be performed can be matched to the type of the material. In the exemplary embodiment, the player character can change the terrain object (e.g., deform the terrain object, or change the material of the terrain object), and therefore, for example, can delete the lava part of the terrain object, or change the lava to another material. Therefore, by changing the terrain object, the player can avoid a reduction in the hit points of the player character due to contact with the lava.

The content of the process to be performed when a collision between the voxel object and another object has been determined, is discretionary. For example, if the other object is a moving object such as the player character or an enemy character, the process may be a process of outputting the sound of footsteps of the object, or displaying an effect (e.g., effect of representing dust or splash of water) on the contact part. In this case, the game system 1 can change the sound of footsteps or the effect according to the type of the material set for the polygon, in the contact part, of the voxel object.

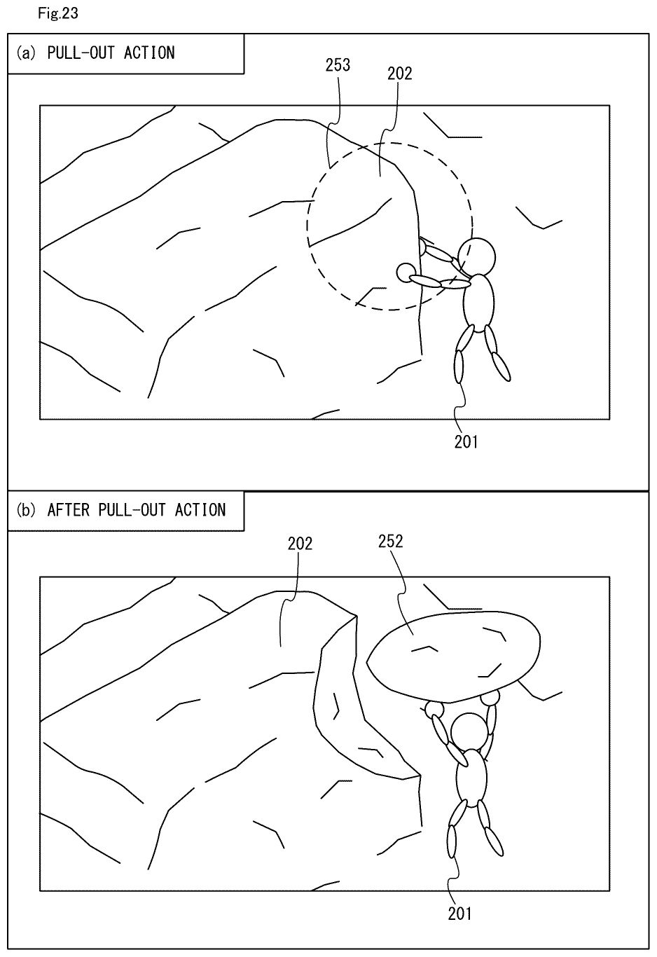

FIG. 23 shows an example of a game image representing a state in which the player character pulls out a fragment object from the terrain object. As shown in FIG. 23, in the exemplary embodiment, the player, through a predetermined operation input, can cause the player character 201 to perform an action of holding the terrain object 202, pulling out a part of the terrain object 202 as a fragment object 252, and grasping the fragment object 252 (hereinafter referred to as “pull-out action”). The game system 1 deletes the part of the terrain object 202 and generates the fragment object 252 as an in-game behavior caused by the pull-out action.

In performing the pull-out action, specifically, the game system 1 executes the following process. That is, when an operation input that causes the player character to perform the pull-out action has been performed by the player, the game system 1 causes the player character to perform an action of digging forward and holding, and performs collision determination. Then, when a collision between the player character performing the pull-out action and the terrain object has been determined, the game system 1 generates an update range 253 based on the position and direction of the player character. For example, the update range 253 is generated in a predetermined direction (e.g., forward) with reference to the player character. The shape and size of the update range may be determined in advance according to the type of the action of the player character. Furthermore, the game system 1 decreases the densities of voxels corresponding to the update range 253. Then, update of the mesh according to the decrease in densities of the voxels causes the terrain object 202 to be deformed such that the part inside the update range 253 is deleted (see (b) of FIG. 23). In the exemplary embodiment, the densities of the voxels corresponding to the update range 253 are decreased. However, voxels whose densities are to be decreased may be at least part of the voxels corresponding to the update range 253.

In the exemplary embodiment, the voxel object corresponding to the update range 253 is unconditionally deformed due to the pull-out action. In other embodiments, the voxel object corresponding to the update range 253 may be deformed on the condition of the amount of damage set for the voxels. For example, instead of unconditionally deforming the voxel object corresponding to the update range 253, the game system 1 may increase the amount of damage set for the voxels corresponding to the update range 253, and decrease the densities of the voxels in response to the amount of damage having exceeded a predetermined value. In this case, the amount of increase in the damage may be determined according to the action performed to the voxel object.

The game system 1 generates the fragment object 252 representing the deleted part of the terrain object 202. That is, based on the pull-out action, the game system 1 generates the fragment object 252 in the state of being held by the player character. The fragment object 252 may be generated so as to have a shape corresponding to the deleted part of the terrain object 202, or a predetermined shape. The fragment object 252 may or may not be a voxel object. When the fragment object is a voxel object, a voxel space different from the voxel space of the voxels corresponding to the terrain object 202 or the like is defined for the fragment object 252.

The game system 1 determines a material of the fragment object 252. The material of the fragment object 252 is determined based on materials set for polygons in a determination mesh that comes into contact with the update range 253 among determination meshes of the terrain object 202. The material of the fragment object 252 is determined to be the same as at least one of the materials set for the polygons in the determination mesh that comes into contact with the update range 253. Thus, the material of the fragment object 252 can be made identical to the material of the deleted part of the terrain object. As is apparent from the above description, the fragment object 252 is actually not a part of the terrain object. However, since the fragment object 252 is generated simultaneously with deletion of a part of the terrain object and takes over the material of the deleted part of the terrain object, an impression that the player character 201 takes out a part of the terrain object 202 by a pull-out action can be given to the player.

In the exemplary embodiment, priorities are set for the types of materials prepared, and the game system 1 determines, as a material of the fragment object 252, a material having the highest priority among the materials set for the polygons of the determination mesh in the update range 253. Here, for example, a case where the determination mesh in the update range 253 includes a polygon whose material is rock and a polygon whose material is lava, is considered. In this case, if the material of the fragment object 252 is set to lava, there is a possibility of inconvenience that the hit points of the player character are reduced because the player character holds the fragment object 252 through the pull-out action (as described with reference to FIG. 22, the lava material has the property of reducing the hit points of the player character if the player character comes into contact with it). Furthermore, as described above, if the determination mesh in the update range 253 includes polygons for which different types of materials are set, it is difficult for the player to predict a material of the fragment object 252, and the above inconvenience may occur against the player's will. Meanwhile, in the exemplary embodiment, since the priorities are given to the materials to be set as a material of the fragment object, the risk of the above inconvenience can be reduced.

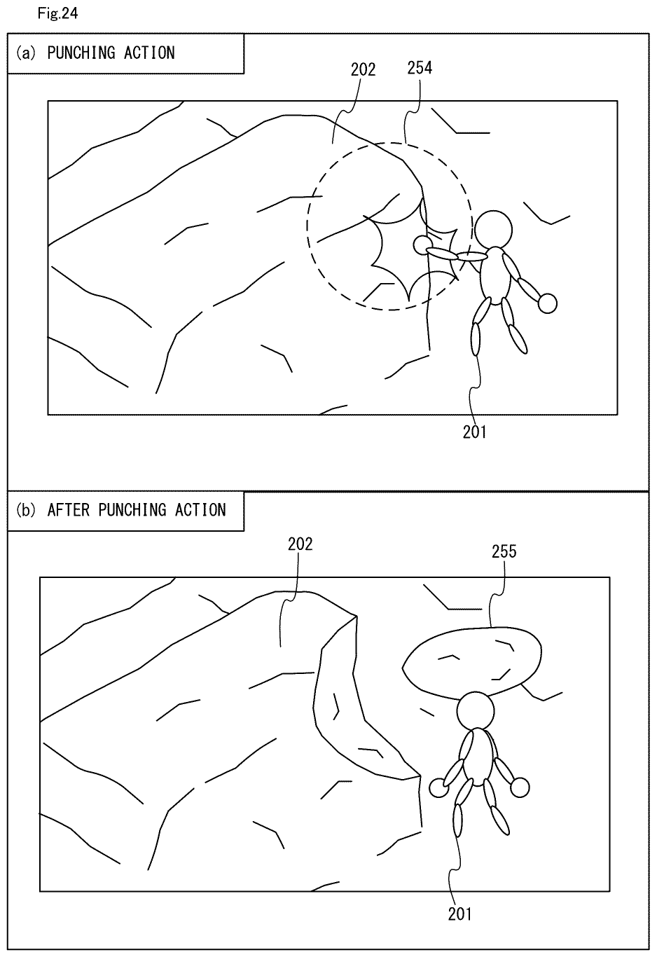

FIG. 24 shows an example of a game image representing a state in which a fragment object is generated because the player character has destroyed the terrain object. As shown in FIG. 24, in the exemplary embodiment, the player, through a predetermined operation input, can cause the player character 201 to perform a punching action. As in the case of the aforementioned pull-out action, the game system 1 deletes a part of the terrain object 202 and generates a fragment object 255, as an in-game behavior caused by the punching action. Specifically, the game system 1 deforms the terrain object 202 such that a part of the terrain object 202 is deleted. In the case of the punching action, unlike the aforementioned pull-out action, the fragment object 255 is not held by the player character 201 but is disposed near the position where the punching action has been performed (see (b) of FIG. 24). Such a fragment according to destruction of the terrain object 202 may not necessarily be generated.

In performing the punching action, specifically, the game system 1 executes the following process. That is, when an operation input to cause the player character to perform the punching action has been performed by the player, the game system 1 causes the player character to perform an action of punching forward, and performs collision determination. Then, when a collision between the player character performing the punching action and the terrain object has been determined, the game system 1 generates an update range 254 based on the position and direction of the player character. For example, the update range 254 is generated in a predetermined direction (e.g., forward) with reference to the player character. The position, shape, and size of the update range 254 due to the punching action may be the same as or different from those of the update range 253 due to the pull-out action. Then, the game system 1 decreases the densities of voxels corresponding to the update range 254. Thus, the terrain object 202 is deformed such that the part inside the update range 254 is deleted by the punching action, similarly to the pull-out action (see (b) of FIG. 24). In the case of the punching action, as in the case of the pull-out action, instead of unconditionally deforming the voxel object corresponding to the update range 254, the game system 1 may increase the amount of damage set for the voxels in the update range 254 according to the punching action, and decrease the densities of the voxels in response to the amount of damage having exceeded a predetermined value. In addition, the voxels whose densities are to be decreased by the punching action may be at least part of the voxels corresponding to the update range 254.

The game system 1 generates a fragment object 255 corresponding to the deleted part of the terrain object 202. That is, based on the punching action, the game system 1 generates the fragment object 255 in the state of not being held by the player character (e.g., in the state of being disposed near the position where the punching action has been performed). The fragment object 255 may be generated so as to have a shape corresponding to the deleted part of the terrain object 202, or a predetermined shape. The fragment object 255 may or may not be a voxel object.

The game system 1 determines a material of the fragment object 255. The material of the fragment object 255 is determined based on materials set for polygons in a determination mesh that comes into contact with the update range 254 among the determination meshes in the terrain object 202. The material of the fragment object 255 is determined to be the same as at least one of the materials set for the polygons in the determination mesh that comes into contact with the update range 254. Thus, the material of the fragment object 255 can be made identical to the material of the deleted part of the terrain object. Since the fragment object 255 is generated simultaneously with deletion of a part of the terrain object and takes over the material of the deleted part of the terrain object, an impression that a part of the terrain object destroyed due to a punching action of the player character is generated as a fragment object can be given to the player.

In the exemplary embodiment, the material of the fragment object 255 is set to a material having the greatest degree of decrease in voxel density among the materials set for the polygons in the determination mesh that comes into contact with the update range 254. This allows generation of a fragment object in which the material composition of the part, of the terrain object, deleted due to the punching action is more accurately shown (e.g., reflected).

The method for determining a material of a fragment object to be generated due to the pull-out action or the punching action is discretionary. For example, the method for determining a material of a fragment object may be the same between the pull-out action and the punching action. Moreover, for example, among the materials set for the polygons of the determination mesh in the update range, a material that is set for the largest number of polygons may be determined as a material of the fragment object. Alternatively, for example, a material that is set for a polygon satisfying a predetermined condition (e.g., a polygon in a position that comes into contact with a hand of the player character performing the pull-out action or the punching action) among the polygons of the determination mesh in the update range, may be determined as a material of the fragment object. In other embodiments, a plurality of types of materials may be set for the fragment object.

In the exemplary embodiment, the player can cause the player character to perform an action of throwing the fragment object 252 or 255 generated as described above (hereinafter referred to as “throwing action”). The player, through a predetermined operation input, can cause the player character to perform an action of holding a fragment object that is generated according to the punching action and placed on the ground. The pull-out action or the action of holding the fragment object after the punching action causes the player character to be in the state of holding the fragment object. In this state, the game system 1 causes the player character to perform an action of throwing the fragment object in a predetermined direction, as the throwing action according to the operation input performed by the player.

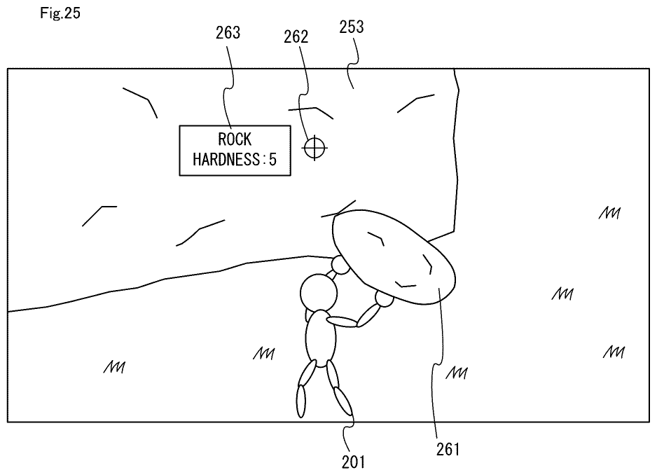

FIG. 25 shows an example of a game image of a scene in which a throwing direction is determined while the player character takes a throwing posture, in the state where a throwing action by the player character is possible. As shown in FIG. 25, in the state where the player character 201 is holding a fragment object 261, the player character 201 can perform a throwing action. In this state, as shown in FIG. 25, the game system 1 displays an aim image 262 (e.g., a reticle) and an object information image 263 on the image showing the game space, as a process of generating an in-game behavior.

The aim image 262 indicates a direction (or aim direction) in which the fragment object is thrown due to the throwing action. That is, in response to an operation input performed by the player for the throwing action, the game system 1 moves the fragment object 261 from the position of the player character 201 toward a position, in the game space, indicated by the aim image 262. The aim direction is controlled based on an operation input performed by the player. For example, the game system 1 may change the aim direction in response to an operation input for changing the direction of a virtual camera. Specifically, the game system 1 may control the virtual camera according to the operation input such that the virtual camera rotates and moves around the player character while maintaining a state in which the player character is within a field-of-view range, and may control the aim direction to be a direction according to the field-of-view direction of the virtual camera. In this case, the aim image 262 pointing a position where a terrain object 264 intersects a straight line extending in the aim direction from the position of the player character, is displayed. Specifically, the game system 1 performs collision determination between the aim direction (e.g., the straight line extending in the aim direction) and the determination mesh of the terrain object 264, and displays the aim image 262 when a collision has been determined. The aim image 262 is arranged so as to point the position of a polygon, in the determination mesh, which intersects the straight line extending in the aim direction.

The aim image 262 allows the position at which the fragment object comes into contact with the voxel object due to the throwing action of the player character to be presented to the player. This allows the player to easily perform the operation for the throwing action. The specific control method for the aim direction and the aim image 262 is discretionary, and a conventional method may be used. For example, in other embodiments, in the state where the aim image 262 is displayed, the aim image 262 may be displayed in a game image in a first-person viewpoint in which the player character is not displayed.

In the state where the player character takes a posture to throw the fragment object, an action of throwing the fragment object to the aim direction is performed in response to a predetermined operation input performed by the player.

The object information image 263 indicates information regarding the terrain object 264 at the position pointed by the aim image 262. In the exemplary embodiment, the object information image 263 indicates the name of the material (“rock” in the example shown in FIG. 25) set for the polygon of the determination mesh at the position pointed by the aim image 262. Thus, the material of the voxel object with which the fragment object thrown by the throwing action comes into contact can be presented to the player. In addition, the object information image 263 indicates information regarding the property (here, hardness) of the material. Thus, the property of the voxel object with which the fragment object thrown by the throwing action comes into contact can be presented to the player. The object information image 263 may have any content. For example, in other embodiments, the object information image 263 may indicate any property regarding the material that is set for the polygon at the position pointed by the aim image 262, or may indicate the state of the polygon (e.g., the amount of damage described above). In the exemplary embodiment, since one type of material is set for the polygon of the determination mesh, the material corresponding to the aim position is specified to one material. This is suitable for displaying the information regarding the material.

In the exemplary embodiment, in response to the result of the collision determination indicating that the fragment object thrown by the throwing action has come into contact with the voxel object, the game system 1 adds a change to the voxel object as an in-game behavior. FIG. 26 shows an example of a game image after a change is added to the terrain object 264 because the fragment object 261 has come into contact with the terrain object 264 shown in FIG. 25. In the example shown in FIG. 26, the terrain object 264 is deformed such that the fragment object is attached to the contact position between the fragment object and the terrain object 264. Specifically, the game system 1 generates an update range that includes the contact position, and increases the densities of voxels in the update range to deform the terrain object 264 to the aforementioned shape. For example, the update range may be set to a shape corresponding to the shape of the fragment object, and the terrain object 264 may be deformed such that the update range is inside the terrain object 264. As described above, in the example shown in FIG. 26, an additional part 265 is added to the terrain object before deformation. In the example shown in FIG. 26, the fragment object is deleted in response to that it comes into contact with the terrain object 264.

A material of a polygon in the additional part 265 is determined based on the material of the fragment object that has come into contact with the terrain object 264. Specifically, the game system 1 sets the material of voxels in the update range to be the material of the fragment object. Then, materials of the display mesh and the determination mesh are determined based on the material of the voxels. In this case, since the appearance of the attached additional part 265 can be made identical to the appearance of the fragment object, an impression that the fragment object is attached to the terrain object 264 (although the terrain object 264 is deformed in actuality) can be more easily given to the player.

In the example shown in FIG. 26, the change added to the voxel object in response to contact of the fragment object with the voxel object is deformation to add the additional part to the voxel object. However, the change to be added to the voxel object is not limited thereto. The change may be a change in voxel density, or a change in material. For example, if the fragment object has a property of explosion, the fragment object may be exploded in response to contact with the voxel object, and in this case, the voxel object may be deformed as if a part of the voxel object is deleted. Specifically, the game system 1 sets an update range so as to include the contact position, and decreases the voxel density in the update range. In addition, for example, when the material of the voxel object is lava and the material of the fragment object is ice, the material of the voxel object may be changed in response to contact with the fragment object. Specifically, the game system 1 may set an update range including the contact position, and change the material being lava, among the materials of voxels in the update range, to obsidian or rock. This allows representation of a state in which the object of lava is cooled by the object of ice and turns into obsidian or rock.

The content of the change may be determined based on the material of the voxel object, the material of the fragment object, or a combination of the material of the voxel object and the material of the fragment object. This allows occurrence of various changes to the voxel object.

The game system 1 may determine whether or not to perform the above change, based on the material of the voxel object, the material of the fragment object, or a combination of the material of the voxel object and the material of the fragment object. For example, the game system 1 may perform the change as shown in FIG. 26 in the case where the fragment object whose material is rock comes into contact with the voxel object whose material is rock, and may not necessarily perform the change as shown in FIG. 26 when the fragment object whose material is rock comes into contact with the voxel object whose material is iron.

In the exemplary embodiment, one type of material is set for each of the polygons of the determination mesh and for the fragment object. If a plurality of types of materials are set for at least either the polygon of the determination mesh or the fragment object, it is difficult to determine the content of a change to be added to the voxel object according to the types of materials of the determination mesh and the fragment object when they come into contact with each other. Meanwhile, in the exemplary embodiment, since one type of material is set for each of the determination mesh and the fragment object that have been determined to be in contact with each other by the collision determination, it is easy to determine the content of a change to be added to the voxel object.

### [2-7. Process Regarding Intersection Information in Response to Deformation of Voxel Object]

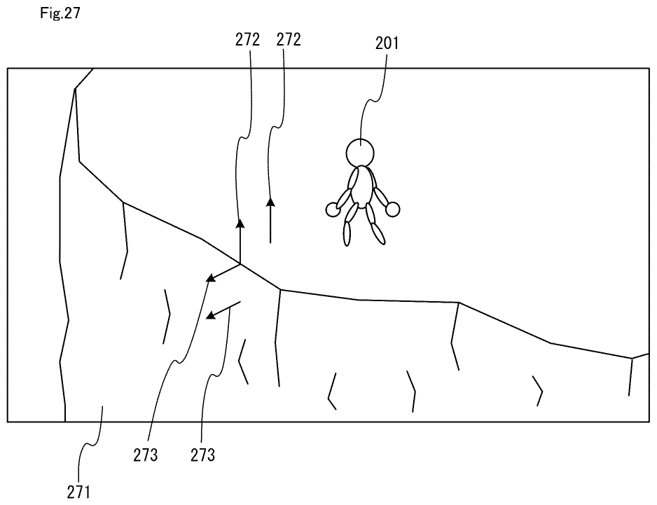

Next, a process executed regarding intersection information set for a voxel, when a voxel object is deformed, will be described with reference to FIG. 27 to FIG. 37.

### [2-7-1. Example of Deleting Intersection Information]

FIG. 27 is a view showing an example of a game image in a case where intersection information is set for a terrain object. In FIG. 27, a terrain object 271 as a voxel object has a shape that forms a cliff. In order to achieve this shape, in the example shown in FIG. 27, intersection information is set for voxels at which a mesh of the terrain object 271 is generated. As an example of vectors representing the intersection information set for the terrain object 271, FIG. 27 shows two vectors 272 pointing upward and two vectors 273 pointing horizontally. However, in actuality, more pieces of intersection information may be set. In actuality, the vectors 272 and 273 are not displayed in the game image.

In the example shown in FIG. 27, intersection information represented as the vectors 272 with an upward direction as its normal direction is set for voxels at a position where a mesh forming an upward-facing surface of the terrain object 271 is generated. Also, for voxels at a position where a mesh forming a surface, of the terrain object 271, facing a predetermined direction parallel to the horizontal direction, intersection information represented as the vectors 273 with the predetermined direction as its normal direction is set. The voxels at the position where the mesh forming the upward-facing surface is generated are voxels whose densities are equal to or greater than the reference value and whose adjacent voxels on the upper side have densities less than the reference value. The voxels at the position where the mesh forming the surface facing the predetermined direction is generated are voxels whose densities are equal to or greater than the reference value and whose adjacent voxels on the side in the predetermined direction have densities less than the reference value. Based on the above intersection information, the mesh of the terrain object 271 is generated so as to have a shape in which the upward-facing surface and the surface facing the predetermined direction are perpendicular to each other. If no intersection information is set for a voxel, it is difficult to generate a mesh with a shape in which two planes are perpendicular to each other at the cliff edge as described above. However, by setting the intersection information, the angle at the cliff edge in the terrain object 271 can be made a right angle or an angle close to a right angle.

FIG. 28 is a view showing an example of game images before and after the terrain object 271 is deformed in the state shown in FIG. 27. In FIG. 28, (a) shows a state in which the player character 201 performs a punching action near the position in the terrain object 271 where intersection information is set. In FIG. 28, (b) shows a state after the punching action of the player character 201 deforms the terrain object 271 as if a part thereof disappears. As shown in FIG. 28, when a punching action is performed on the terrain object 271, the voxel density of the terrain object 271 is decreased, whereby the terrain object 271 is deformed as if a part thereof is deleted, as in the example shown in FIG. 24. Specifically, the game system 1 sets an update range based on the punching action, and deforms the mesh of the terrain object 271 by decreasing the densities of voxels in the update range.

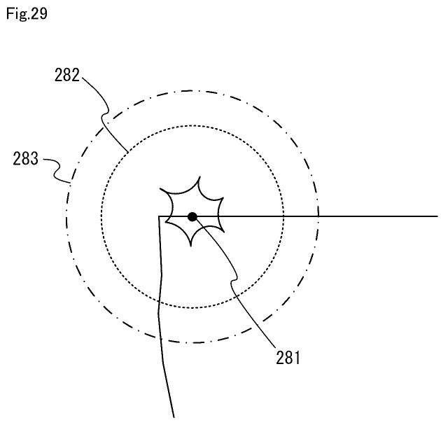

In the exemplary embodiment, when a voxel object is deformed, the game system 1 sets a deletion range in which intersection information is deleted. In the exemplary embodiment, like an update range 282, a deletion range 283 is represented by an SDF. FIG. 29 is a view showing an example of an update range and a deletion range set for a terrain object. As shown in FIG. 29, the update range 282 is set so as to include, for example, a position 281 based on the punching action. In the exemplary embodiment, like the update range 282, the deletion range 283 is set so as to include the position 281 based on the punching action. A specific method for determining the deletion range 283 is discretionary. For example, the deletion range 283 may be determined based on the position where the punching action is performed or on the update range 282 based on the position. In the exemplary embodiment, the deletion range 283 is set so as to include the update range 282. Specifically, the game system 1 determines the deletion range 283 by expanding the update range 282. This makes it easy to generate the deletion range 283 including the update range 282. Furthermore, in the exemplary embodiment, the center position of the deletion range 283 is set at the same position as the center position of the update range 282. However, the deletion range 283 may be set at any position that includes the update range 282. In the example shown in FIG. 29, the deletion range 283 is larger than the update range 282. However, in other embodiments, the deletion range 283 may be the same as the update range 282. Each of the update range 282 and the deletion range 283 has a spherical shape in the example shown in FIG. 29, but may have any shape. In other embodiments, the update range 282 and the deletion range 283 may not necessarily have similar shapes.

The game system 1 deletes the intersection information that is set for the voxels in the deletion range set as described above (see FIG. 28 and FIG. 29). Then, when generating a mesh after deformation of the terrain object 271, the game system 1 sets vertices based on the voxel density, without being based on the intersection information, and generates a mesh based on the vertices. The method for generating a mesh based on vertices is the same as the method described in the above [2-4. Simplification of vertices] and [2-5. Generation of mesh]. Therefore, in the state shown in (b) of FIG. 28, the shape of a portion, of the mesh of the terrain object 271, which is deformed as if a part thereof is deleted is defined not based on the intersection information that was set before deformation.

As described above, in the exemplary embodiment, since the intersection information within the deletion range is deleted, calculation of performed without using the intersection information when a mesh is generated after deformation in response to the action, thereby suppressing an increase in processing load in the game system 1. In addition, the amount of memory used for mesh generation can be reduced. In the example shown in FIG. 28, the mesh after deformation of the terrain object 271 is less likely to have sharp vertices because the intersection information is not used. Therefore, the shape of the terrain object 271 after deformation can be made more natural as the shape after destruction by the punching action.

The above phrase “deleting intersection information” means deleting intersection information in data used for setting vertices (or generating a mesh) and means that the game system 1 itself may have, stored therein, data of the intersection information as data separate from the data used for vertex setting. For example, when a predetermined condition is satisfied in the game, a voxel object such as a terrain object arranged in the game space may be reset to its initial shape. In this case, a mesh in the initial shape may be generated using the stored data of the intersection information.

As described above, in the example shown in FIG. 28, deformation is performed such that the volume of the internal region of the terrain object 271 is decreased. For example, as shown in FIG. 26, even when deformation is performed such that the volume of the internal region of the terrain object 271 is increased, the game system 1 may set a deletion range, and delete intersection information set for voxels within the deletion range.

### [2-7-2. Example of Retaining Intersection Information]

In the exemplary embodiment, under certain conditions, intersection information may be retained when a voxel object is deformed. Hereinafter, an example of retaining intersection information will be described.

In the exemplary embodiment, a correspondence relationship is set between two voxel objects, and one of the voxel objects is deformed in response to deformation of the other voxel object. For example, the game system 1 generates meshes of the voxel objects such that the two voxel objects have mutually complementary shapes. In this case, intersection information regarding the voxel objects may be retained without being deleted in response to deformation of the voxel objects.

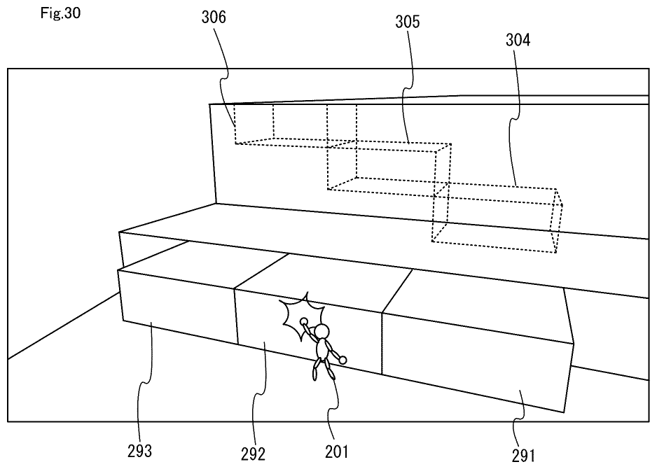

Hereinafter, a process of changing the shapes of two voxel objects for which a correspondence relationship is set will be described with reference to FIG. 30 to FIG. 35. In the following description, one of the two voxel objects for which a correspondence relationship is set is referred to as “first correspondence object” and the other voxel object is referred to as “second correspondence object”. The term “correspondence object” refers collectively to both the first correspondence object and the second correspondence object.

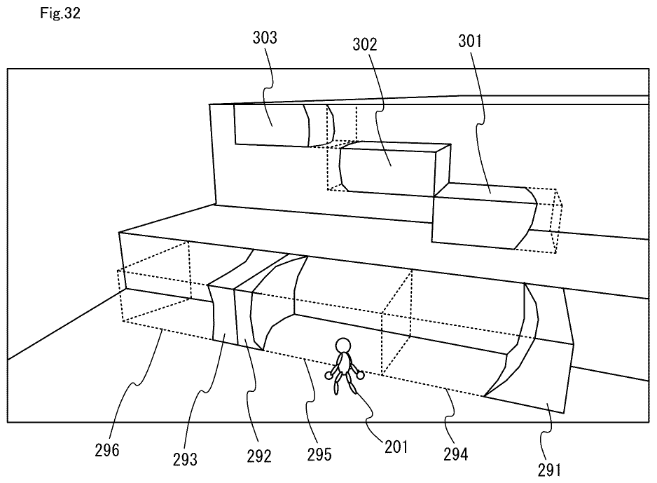

FIG. 30 is a view showing an example of a game image representing a game space in which first correspondence objects are placed. In the example shown in FIG. 30, three first correspondence objects 291 to 293 are placed in the game space. Second correspondence objects (objects 301 to 303 shown in FIG. 32) are set for the first correspondence objects 291 to 293, respectively. In the state shown in FIG. 30, the second correspondence objects are not displayed because the density of each voxel is 0 and they do not exist.

In the exemplary embodiment, the respective correspondence objects are voxel objects corresponding to different voxel spaces. That is, a different voxel space is set for each correspondence object. In other embodiments, a plurality of correspondence objects may share a voxel space. In the example shown in FIG. 30, the voxel space for each correspondence object is the aforementioned sub voxel space, which is a rectangular parallelepiped space. In the example shown in FIG. 30, each of the first correspondence objects 291 to 293 has a shape (hereinafter referred to as “maximum shape”) in which the volume of the internal region is maximum. In other words, the surface and the internal region of the first correspondence object occupy the entire voxel space. In this case, the density of each voxel in the first correspondence objects 291 to 293 is an upper limit value (specifically, 255).

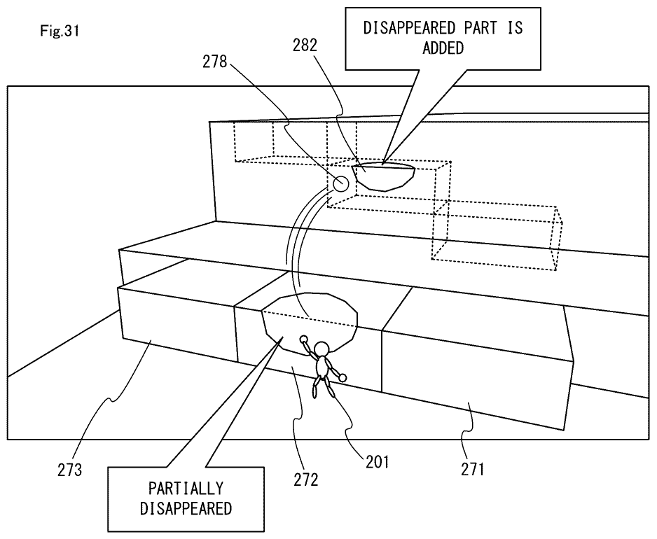

In the example shown in FIG. 30, the player character 201 performs a punching action to the first correspondence object 292. FIG. 31 is a view showing an example of a game image representing a state after a punching action has been performed from the state shown in FIG. 30. When a punching action is performed to the first correspondence object 292, the voxel density of the first correspondence object 292 is decreased, whereby the first correspondence object 292 is deformed as if a part (or the entirety) thereof is deleted, as in the example shown in FIG. 24 (see FIG. 31).

In the exemplary embodiment, when the first correspondence object 292 is deformed as described above, the game system 1 also deforms the second correspondence object 302 corresponding to the first correspondence object 292. Specifically, the game system 1 increases the voxel density of the second correspondence object 302 when the voxel density of the first correspondence object 292 is decreased. Thus, as shown in FIG. 31, the second correspondence object 302 is deformed such that the volume of the internal region thereof is increased. In the example shown in FIG. 30 and FIG. 31, the state where the second correspondence object 302 does not exist is changed to the state where the second correspondence object 302 exists. As will be described in detail below, in the exemplary embodiment, the shape of the added part of the second correspondence object 302 is the same as the shape of the disappeared part of the first correspondence object 292.

FIG. 32 is a view showing an example of a game image representing a state after a punching action has been further performed to the first correspondence objects 291 to 293 from the state shown in FIG. 31. In the example shown in FIG. 32, each of the first correspondence objects 291 to 293 is deformed as if a part thereof disappears, in response to the punching action by the player character 201. In this case, in response to deformation of the first correspondence objects 291 to 293, the second correspondence objects 301 to 303 are deformed such that the disappeared parts of the first correspondence objects 291 to 293 are added to the second correspondence objects 301 to 303. If a first correspondence object is small and the entire first correspondence object is included in the update range based on the punching action, the entire first correspondence object disappears in response to the punching action by the player character 201. In this case, the second correspondence object is deformed so as to have the maximum shape described above.

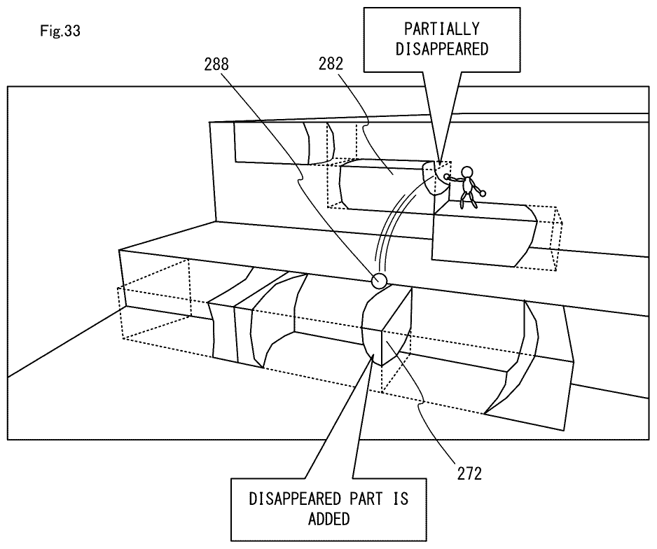

FIG. 33 is a view showing an example of a game image representing a state after a punching action has been performed to the second correspondence object 302 in the state shown in FIG. 32. In the exemplary embodiment, even when a punching action is performed to the second correspondence object 302, the game system 1 deforms the second correspondence object 302 as if a part of the second correspondence object 302 disappears, as in the case of the first correspondence object. In this case, the first correspondence object 292 corresponding to the second correspondence object 302 is deformed. Specifically, the first correspondence object 292 is deformed such that the disappeared part of the second correspondence object 302 is added to the first correspondence object 292 (see FIG. 33). As described above, in the exemplary embodiment, even when the second correspondence object is deformed, the corresponding correspondence object is deformed as in the case where the first correspondence object is deformed.

As described above, in the exemplary embodiment, when one correspondence object is deformed, corresponding another object is also deformed. Thus, for example, by making a certain correspondence object smaller, a correspondence object located at another position can be made larger to create footholds or barriers against enemies, whereby the strategy of the game can be enhanced. In the example shown in FIG. 30, the correspondence objects are used as footholds for the player character. However, the correspondence objects may be used for any purpose in the game.

In the exemplary embodiment, as an example of images indicating the positions where the correspondence objects 291 to 293 and 301 to 303 are placed, frame images 294 to 296 and 304 to 306 are displayed (see FIG. 30 to FIG. 32), respectively. Therefore, even if no correspondence object exists, such as the second correspondence object shown in FIG. 30, the frame image can notify the user of the position where the correspondence object will be placed. Furthermore, in the exemplary embodiment, the frame image shows the outer shape of a correspondence object when the correspondence object has the maximum shape. Therefore, in the exemplary embodiment, the frame image can notify the user of the range in which the correspondence object is placed, in addition to the position of the correspondence object. In other embodiments, an image showing the position where an object is placed may be in any form. For example, the image may be an image showing the center position of the object. In other embodiments, the image may not necessarily be displayed.

Next, a process of updating densities to deform, in response to deformation of a correspondence object, a correspondence object corresponding to the correspondence object, will be described. First, the game system 1 stores therein correspondence information indicating a correspondence relationship between the first correspondence object and the second correspondence object. For example, the game system 1 stores, as correspondence information, information that associates voxel data regarding the first correspondence object with voxel data regarding the second correspondence object. The correspondence information may be in any form. For example, in other embodiments, voxel data may include, as correspondence information, information indicating a voxel object (or voxel data) corresponding to a voxel object having the voxel data. When a correspondence object is deformed by an action that deforms a voxel object, the game system 1 may refer to the correspondence information and specify a correspondence object corresponding to the deformed correspondence object.

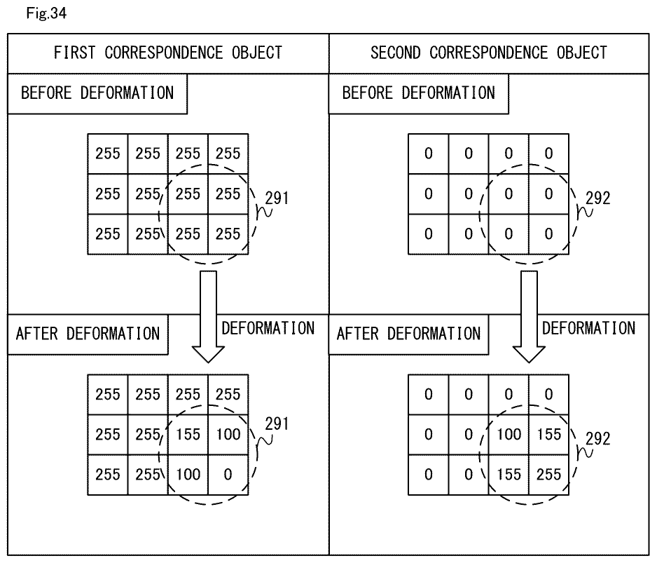

FIG. 34 is a view showing an example of density values that are set for voxels of the first correspondence object and the second correspondence object. In FIG. 34, for the purpose of making the drawing easier to see and the description easier to understand, voxels are arranged two-dimensionally in a two-dimensional voxel space. However, in actuality, voxels are arranged three-dimensionally in a three-dimensional voxel space. In FIG. 34, one square represents one voxel, and the numerical value in each square indicates the density set for the voxel. In the example shown in FIG. 34, the density of each voxel of the first correspondence object before deformation is set to an upper-limit value (here, 255), and the density of each voxel of the second correspondence object at this time is set to a lower-limit value (here, 0). That is, the state before deformation shown in FIG. 34 is a state where the first correspondence object has the maximum shape and there is no second correspondence object, like the state shown in FIG. 30.

When an action to deform the first correspondence object has been performed by the player character or the like, an update range 311 is set based on the action, and the densities of voxels in the update range 311 are updated to be decreased. In the example shown in FIG. 34, four voxels in the lower right, among the voxels of the first correspondence object, are within the update range 311, and the densities of these four voxels are updated to 150, 100, 100, and 0, respectively. By generating a mesh based on the updated densities, the first correspondence object is deformed.

When the first correspondence object has been deformed as described above, the game system 1 sets an update range 312 for the second correspondence object. The update range 312 regarding the second correspondence object is set to be the same as the update range 311 regarding the first correspondence object. Specifically, the update range 312 is set such that the positional relationship between the voxel space regarding the second correspondence object and the update range 312 is the same as the positional relationship between the voxel space regarding the first correspondence object and the update range 311.

The game system 1 updates the density of a voxel in the update range 312. In the exemplary embodiment, the density of the voxel in the update range 312 is increased in response to a decrease in the density of a voxel in the update range 311. Here, in the exemplary embodiment, the voxels of the first correspondence object are respectively associated with the voxels of the second correspondence object. Specifically, each voxel is given an identification number according to the position of the voxel in the voxel space, and a voxel of the first correspondence object and a corresponding voxel of the second correspondence object are given the same number. The game system 1 can specify the voxel of the second correspondence object corresponding to the voxel of the first correspondence object by referring to the identification number. A specific method for associating a voxel of the first correspondence object with a voxel of the second correspondence object is discretionary. For example, in other embodiments, voxel data may include information indicating a voxel corresponding to a voxel concerned among voxels of another voxel object corresponding to a voxel object concerned.

In the exemplary embodiment, as for a voxel in the update range 312 of the second correspondence object, the game system 1 increases the density of this voxel by an amount corresponding to the amount of decrease in density of a voxel (voxel in the update range 311 of the first correspondence object) corresponding to this voxel. For example, in the example shown in FIG. 34, since the density of a voxel in the lower right, among the voxels in the update range 311, is decreased from 255 to 0, the density of a voxel corresponding to this voxel is increased from 0 to 255. Thus, in the exemplary embodiment, the game system 1 increases the density of a voxel of the second correspondence object by an amount equal to the amount of decrease in density of a voxel of the first correspondence object. This makes it possible to add the second correspondence object by the amount of decrease in the first correspondence object.

In the exemplary embodiment, the density of a voxel of the second correspondence object is calculated such that the sum of this density and the density of a voxel of the first correspondence object corresponding to the voxel is the upper limit value (here, 255) of density. For example, in the example shown in FIG. 34, the densities of the voxels in the update range 311 are 155, 100, 100, and 0 after deformation, and the densities of the voxels in the update range 312 corresponding to these voxels are 100, 155, 155, and 255. Thus, the shape of the first correspondence object and the shape of the second correspondence object can be mutually complementary. For example, in the example shown in FIG. 30 to FIG. 33, the shapes of the first correspondence object and the second correspondence object are set such that the first correspondence object and the second correspondence object, when combined, form a rectangular parallelepiped. Thus, the correspondence relationship between the first correspondence object and the second correspondence object can be easily understood by the player. For example, even when a plurality of first correspondence objects are arranged as shown in FIG. 30, it becomes easier for the player to understand which second correspondence object corresponds to a certain first correspondence object. In other embodiments, the sum of the density of a voxel of the first correspondence object and the density of a voxel of the second correspondence object corresponding to the voxel may not necessarily be the upper limit value of density.

In the exemplary embodiment, the shapes of the first correspondence object and the second correspondence object are mutually complementary. However, this does not mean that the shape formed by combining the first correspondence object and the second correspondence object has to be strictly fixed. For example, when a mesh of a voxel object is generated based on the densities set for voxels as in the exemplary embodiment, the mesh plane of the first correspondence object may not exactly match the mesh plane of the second correspondence object (although they roughly match). Even when the mesh plane of the first correspondence object does not exactly match the mesh plane of the second correspondence object, it can be said that the shapes of the first correspondence object and the second correspondence object are mutually complementary.

The process of deforming a first correspondence object in response to deformation of a second correspondence object is similar to the process of deforming a second correspondence object in response to deformation of a first correspondence object. Specifically, the game system 1 sets, in the voxel space of the first correspondence object, the update range corresponding to the update range that is set based on an action to deform the second correspondence object, and increases the density of each voxel in the update range by an amount equal to the amount of decrease in density of a corresponding voxel (voxel of the second correspondence object). Thus, in the exemplary embodiment, as for two voxel objects between which a correspondence relationship is set, the process in which deformation of one voxel object affects the other voxel object can be performed bidirectionally.

In the exemplary embodiment, deformation in which the voxel density of the correspondence object is increased may be performed by an action performed by the player character. When the voxel density of a certain correspondence object is increased, the game system 1 decreases the voxel density of a correspondence object corresponding to the certain correspondence object. The density calculation method in this case is the method in which the sum of the voxel density of the first correspondence object and the voxel density of the corresponding second correspondence object is calculated to be the upper limit value of density, like the method shown in FIG. 34. Thus, even when deformation in which the voxel density of the correspondence object is increased by an action is performed, the two correspondence objects can be made to have mutually complementary shapes.

There is a case where the update range based on the action to deform the correspondence object spans a plurality of correspondence objects. In this case, in the exemplary embodiment, the game system 1 deforms the plurality of correspondence objects, and deforms, in response to the deformation, correspondence objects corresponding to the plurality of correspondence objects. For example, when the update range based on the action spans a plurality of first correspondence objects, the plurality of first correspondence objects are deformed, and a plurality of second correspondence objects are deformed in response to the deformation. Also, for example, when the update range based on the action spans a first correspondence object and a second correspondence object, these correspondence objects are deformed, and a second correspondence object and a first correspondence object respectively corresponding to these correspondence objects are deformed in response to the deformation. In the above case, the game system 1 executes, for each correspondence object, the process of updating the voxel density by the aforementioned method.

In the exemplary embodiment, the first correspondence object and the second correspondence object have the same number and size of voxels in the voxel space. Therefore, there is one-to-one correspondence between the voxels of the first correspondence object and the voxels of the second correspondence object. In other embodiments, the number and size of voxels of the first correspondence object may be different from those of the second correspondence object.

Even when the first correspondence object and the second correspondence object have the same number of voxels but different sizes, the second correspondence object can be deformed in response to deformation of the first correspondence object by updating the voxel density of the second correspondence object in response to deformation of the first correspondence object as in the exemplary embodiment. In this case, the size of the first correspondence object and the size of the second correspondence object, when reaching the maximum shape, are different sizes.

When the number of voxels is different between the first correspondence object and the second correspondence object, a correspondence relationship between the voxels of the first correspondence object and the voxels of the second correspondence object may be set as follows. That is, for example, if the number of voxels of the first correspondence object is less than the number of voxels of the second correspondence object, each of the voxels of the first correspondence object may be associated with some of the voxels of the second correspondence object while some of the voxels of the second correspondence object are associated with none of the voxels of the first correspondence object. In this case, when the first correspondence object is deformed in response to deformation of the second correspondence object, the game system 1 updates, for example, the density of a voxel of the first correspondence object, based on the density of the corresponding voxel of the second correspondence object. Also, in the above case, when the second correspondence object is deformed in response to deformation of the first correspondence object, the game system 1 updates the density of a voxel, among the voxels of the second correspondence object, which is associated with a voxel of the first correspondence object, based on the density of the corresponding voxel of the first correspondence object, and updates the density of a voxel which is not associated with a voxel of the first correspondence object, based on interpolation using the density of the voxel associated with the voxel of the first correspondence object. As described above, even when the number of voxels is different between the first correspondence object and the second correspondence object, it is possible to deform one correspondence object in response to deformation of the other correspondence object.

In other embodiments, if the number of voxels of the first correspondence object is less than the number of voxels of the second correspondence object, each voxel of the second correspondence object may be associated with any of the voxels of the first correspondence object. In this case, a plurality of voxels of the second correspondence object are associated with one voxel of the first correspondence object. In this case, when the densities of the plurality of voxels of the second correspondence object are changed, the game system 1 may update the density of the one voxel of the first correspondence object corresponding to the plurality of voxels, based on the densities of the plurality of voxels. For example, the density of the one voxel of the first correspondence object corresponding to the plurality of voxels may be updated so as to be increased by an average value of the amounts of decrease in the densities of the plurality of voxels.

In the example shown in FIG. 30 to FIG. 33, the voxel spaces of the first correspondence object and the second correspondence object are both rectangular parallelepipeds, and the voxel spaces are arranged in the same direction in the game space, but the voxel spaces may not necessarily be arranged in the same direction. For example, one voxel space may be arranged in a vertically elongated direction, and the other voxel space may be arranged in a horizontally elongated direction. Also, for example, one voxel space and the other voxel space may be arranged inversely. For example, the relationship between one voxel and the corresponding voxel may be point-symmetric or line-symmetric. In this case, the update range set in the other voxel space corresponding to the update range set in one voxel space is set such that the positional relationship between the other voxel space and the update range is the same as the positional relationship obtained by inverting the positional relationship between the one voxel space and the update range.

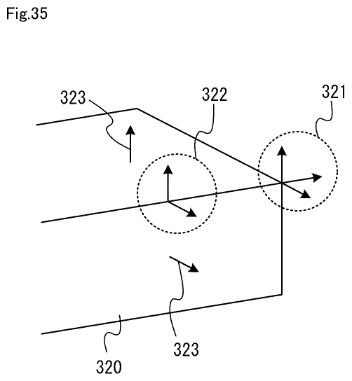

The aforementioned intersection information is set for some of the voxels of the first correspondence object and the second correspondence object. FIG. 35 is a view showing an example of intersection information set to a correspondence object. In FIG. 35, the density of each voxel of a correspondence object 320 is the upper limit value, and therefore the correspondence object 320 has the maximum shape. In the example shown in FIG. 35, intersection information is set to a voxel at a position where the mesh of the correspondence object 320 having the maximum shape is generated. Specifically, as for a voxel at the position corresponding to a corner of the correspondence object 320 having the maximum shape, intersection information is set to be represented as three vectors 321 respectively perpendicular to three planes forming the corner. As for a voxel at the position corresponding to an edge of the correspondence object 320 having the maximum shape, intersection information is set to be represented as two vectors 322 respectively perpendicular to two planes forming the edge. As for a voxel at the position corresponding to a plane of the correspondence object 320 having the maximum shape, intersection information is set to be represented as a vector 323 perpendicular to the plane. In actuality, the vectors 321 to 323 are not displayed as game images. By setting the intersection information as described above, the mesh of the correspondence object 320 can be made into a more accurate rectangular parallelepiped as shown in FIG. 35. FIG. 35 shows some of the vectors representing the intersection information set for the correspondence object 320; in actuality, more pieces of intersection information are set. For example, in FIG. 35, only one vector is shown for one edge or plane; in actuality, a plurality of pieces of intersection information may be set for one edge or plane.

In the exemplary embodiment, when a correspondence object for which intersection information is set is deformed by an action such as a punching action described above or when it is deformed in response to deformation of a corresponding correspondence object, the intersection information is retained. In the exemplary embodiment, intersection information is used to set vertices when the intersection information is set between a voxel whose density is equal to or greater than the reference value and a voxel whose density is less than the reference value (e.g., when shown in FIG. 16 or FIG. 17); whereas intersection information is not used to set vertices when the intersection information is set between voxels whose densities are both equal to or greater than the reference value or voxels whose densities are both less than the reference value. Therefore, when the densities of the voxel at the position where the intersection information is set and the neighboring voxels are updated to 0, setting of vertices is performed without using the intersection information. Therefore, a vertex of a mesh is not set to a certain voxel even though the densities of this voxel and its neighboring voxels are 0.

When the densities of the voxels of the correspondence object are updated to the upper limit value from the state where the densities of the voxel at the position where the intersection information is set and the neighboring voxels are 0, a mesh is generated with vertices being set based on the retained intersection information. Therefore, in the exemplary embodiment, even when the correspondence object is temporarily deformed as if a part thereof is deleted and then is further deformed to return to its maximum shape, the correspondence object is restored to a more accurate rectangular parallelepiped.

In other embodiments, when intersection information is set to a voxel whose density is decreased (more specifically, whose density is decreased to a value less than the reference value) when a correspondence object is deformed, the game system 1 may delete the intersection information. In this case, a deletion range in which the intersection information is deleted may be the same range as an update range in which the densities of voxels are updated. In this case, the game system 1 may set the same intersection information as the deleted intersection information, for a voxel which is included in a correspondence object corresponding to the correspondence object from which the intersection information is deleted, and which corresponds to the voxel from which the intersection information is deleted. Thus, as for the correspondence object in which the voxel density is decreased, the intersection information having no influence on vertex setting is deleted, whereby an increase in processing load can be suppressed. Also, as for the correspondence object in which the voxel density is increased, vertices are set based on the same intersection information as the intersection information deleted in the corresponding correspondence object, and therefore a mesh can be generated so as to accurately reproduce the shape of the corresponding correspondence object.

The above phrase “the same intersection information as the deleted intersection information” means that the positional relationship between the voxel space, and the intersection coordinates and normal direction indicated by the intersection information is the same for the correspondence object from which the intersection information is deleted and the corresponding correspondence object. When one voxel space and the other voxel space are arranged inversely, the positional relationship is determined, considering the inversion. Therefore, when one voxel space and the other voxel space are arranged inversely, the above phrase “the same intersection information as the deleted intersection information” refers to intersection information indicating intersection coordinates and normal direction obtained by inverting the intersection coordinates and normal direction indicated by the deleted intersection information, in the same manner as the voxel space.

In the exemplary embodiment, the game system 1 generates an effect image 298 as shown in FIG. 31, when the second correspondence object is deformed in response to deformation of the first correspondence object as if a part thereof is deleted. The effect image 298 is displayed so as to move from the deformed first correspondence object 292 to the second correspondence object 302. Also, the game system 1 generates an effect image 308 as shown in FIG. 33, when the first correspondence object is deformed in response to deformation of the second correspondence object as if a part thereof is deleted. The effect image 308 is displayed so as to move from the deformed second correspondence object 302 to the first correspondence object 292. The effect image can notify the player of the correspondence object corresponding to the deformed correspondence object.

In the exemplary embodiment, the effect images 298 and 308 move from a start position within a first range including at least voxels whose densities are decreased to a target position within a second range including at least voxels whose densities are increased. Thus, the player can be notified of a part, of the correspondence object, that appears to be deleted and a part, of a correspondence object corresponding to the correspondence object, that appears to be added. The first range may be, for example, a range composed of voxels whose densities are decreased, and the start position in the first range may be, for example, the center position in the range. Also, the second range may be, for example, a range composed of voxels whose densities are increased, and the target position in the second range may be, for example, the center position in the range.

FIG. 31 and FIG. 33 each show a game image in which deformation to delete a part of a correspondence object, display of the effect image 298 or 308, and deformation to add a part of a correspondence object corresponding to the correspondence object are performed simultaneously. However, in the exemplary embodiment, in actuality, an effect image is displayed at a position within the first range of a correspondence object in response to that the correspondence object is deformed as if a part thereof is deleted, and thereafter, the effect image moves to a position within the second range of a corresponding correspondence object, and then the corresponding correspondence object is deformed as if a part thereof is added. Thus, the two correspondence objects having the correspondence relationship can be made easier to understand. Also, it is possible to make a representation in which the decreased part of one correspondence object moves towards the other correspondence object.

An effect image may also be displayed when, in response to deformation of a part of a correspondence object, a correspondence object corresponding to the correspondence object is deformed as if a part thereof is deleted. For example, when deformation to delete a part of the second correspondence object is performed in response to deformation to add a part of the first correspondence object, the effect image may be displayed so as to move from the first correspondence object to the second correspondence object, or may be displayed so as to move from the second correspondence object to the first correspondence object.

For correspondence objects, materials may be determined by any method. For example, materials different from each other may be set for the voxels of the first correspondence object and the voxels of the second correspondence object so that the first correspondence object and the second correspondence object have different appearances. The same material may be set for the voxels of the first correspondence object and the voxels of the second correspondence object. Materials may not necessarily be set for the correspondence objects.

As described above, in the exemplary embodiment, intersection information is deleted when the voxel density is updated in response to a first action performed on the first voxel object (e.g., terrain object 271 shown in FIG. 28), while intersection information is not deleted when the voxel density is updated in response to a second action performed on the second voxel object (e.g., first correspondence object 292 shown in FIG. 30). Thus, an increase in processing load due to the mesh generation process using intersection information can be suppressed, and moreover, by retaining intersection information for a predetermined voxel object, the shape of a mesh can be restored to the original shape more accurately when the density of the voxel object is restored.

The “first action” and the “second action” may refer to two actions having different operation contents, or two actions to be performed on different voxel objects. In the exemplary embodiment, intersection information is deleted when a punching action is performed on a terrain object, while intersection information is retained when a punching action is performed on a correspondence object. In other embodiments, intersection information may be deleted when a punching action is performed on a terrain object, while intersection information may be retained when an action (e.g., body hitting) whose content is different from the punching action is performed on the terrain object.

### [2-7-3. Example of Adding Intersection Information]

In the exemplary embodiment, a process of setting new intersection information may be executed in response to deformation of a voxel object. Hereinafter, an example of setting new intersection information will be described.

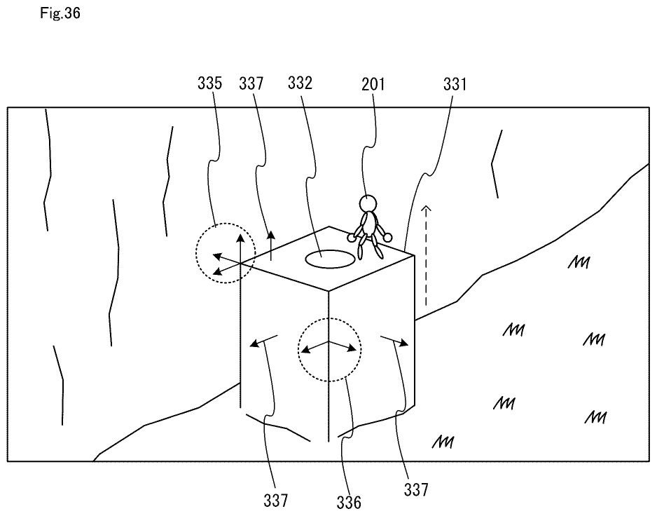

FIG. 36 shows an example of a game image in a state where a part of a terrain object is deformed as if it rises upward. In the example shown in FIG. 36, a voxel object 331 that is a part of the terrain object is deformed to rise upward from the ground as if a quadrangular prism extends upwards. The voxel object 331 may be deformed according to any conditions. In the example shown in FIG. 36, for example, the voxel object 331 is deformed when the player character 201 performs a predetermined action on an object 332 placed on the upper surface of the voxel object 331 (e.g., action of hitting the object 332).

When the voxel object 331 is deformed as shown in FIG. 36, the game system 1 increases the densities of voxels in a range above the upper surface of the voxel object 331 before deformation to values equal to or greater than a reference value. A specific method for deforming the voxel object 331 is discretionary. For example, the game system 1 prepares an SDF representing the shape of a quadrangular prism, moves the shape of the quadrangular prism upward from the ground in a voxel space, and sets a new range inside the quadrangular prism as a voxel update range. An update range setting method is discretionary. The update range may be set based on the position where a predetermined action is performed by the player character 201, or may be set to a predetermined position. Increasing the densities of voxels in the update range allows the voxel object 331 to deform as if it rises upward. Moreover, for example, repeating the above deformation over a plurality of frames allows the voxel object 331 to deform as if it gradually extends upward.

In the exemplary embodiment, new intersection information is set for voxels whose densities are increased in the process of performing the above deformation. For example, intersection information is set based on the SDF used for setting of the update range, or based on the set update range. For example, intersection information is set such that the position of the intersection coordinates is on the surface represented by the SDF or the outline shape of the update range and the normal direction is perpendicular to the surface. In the example shown in FIG. 36, intersection information is set for voxels positioned on the side surfaces and the upper surface of the quadrangular prism, among the voxels whose densities are increased. FIG. 36 shows vectors 335 to 337 (see solid-line arrows) representing some pieces of set intersection information. In the example shown in FIG. 36, intersection information is set such that the positions of the intersection coordinates are on the upper surface and the side surfaces of the quadrangular prism, and normal directions are perpendicular to the surfaces of the quadrangular prism at the positions. Specifically, as for a corner portion formed by the side surfaces and the upper surface of the quadrangular prism, intersection information is set to be represented as three vectors 335 respectively perpendicular to the three planes forming the corner. As for an edge portion formed by two side surfaces or a side surface and the upper surface of the quadrangular prism, intersection information is set to be represented as two vectors 336 respectively perpendicular to the two planes forming the edge. As for each of the side surfaces and the upper surface of the quadrangular prism, intersection information is set to be represented as a vector 337 perpendicular to this plane. The game system 1 generates a mesh of the deformed voxel object 331, based on the intersection information. Thus, the mesh of the deformed voxel object 331 can be made into a more accurate quadrangular prism.

In the example shown in FIG. 36, new intersection information is set when deformation to increase the voxel density is performed. However, new intersection information may also be set when deformation to decrease the voxel density. For example, when a predetermined action performed the player character causes deformation that creates a hole in a terrain object, intersection information may be set for voxels positioned on the side surface of the hole. For example, when creating a hole in the shape of a quadrangular prism, intersection information are set to indicate intersection coordinates indicating a position on the side surface of the quadrangular prism, and the normal direction perpendicular to the side surface at the position.

As described above, the game system 1 may update the densities of voxels in the update range, and set intersection information for some voxels among the voxels whose densities have been updated. This makes it easier to achieve the intended shape of the mesh of the deformed voxel object.

### [2-7-4. Process When Voxel Object is Restored]

In the exemplary embodiment, intersection information deleted in response to deformation of a voxel object may be restored in response to restoration of the shape of the voxel object. Hereinafter, an example of restoration of intersection information will be described.

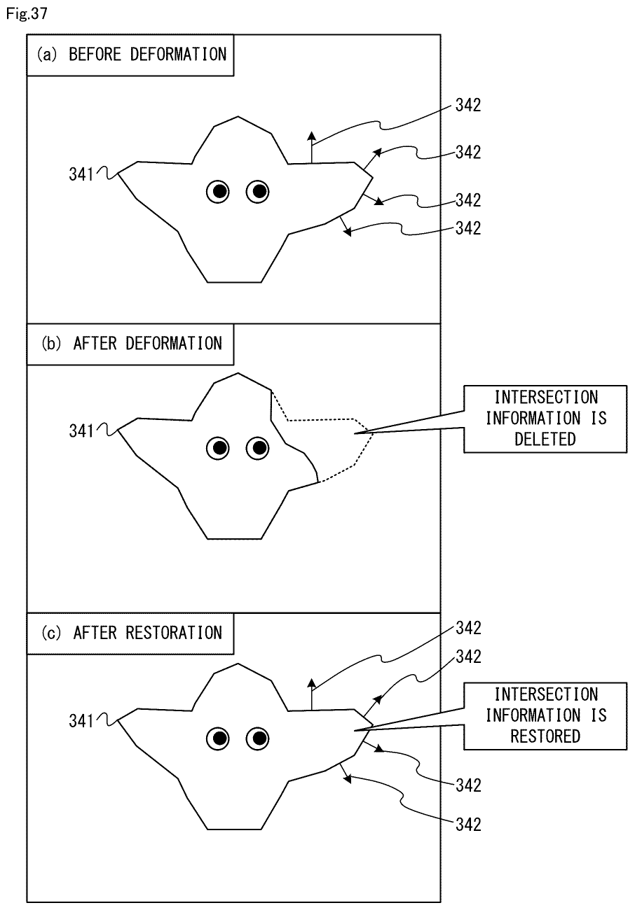

FIG. 37 is a view showing an example of how a deformed character object is restored. In the example shown in FIG. 37, for a character object 341 as a voxel object, intersection information represented as vectors 342 is set for some voxels among voxels regarding the character object 341. Furthermore, in the example shown in FIG. 37, the character object 341 is deformed as if a part thereof is deleted under predetermined conditions (see (b) of FIG. 37), and thereafter is restored to the original shape (see (c) of FIG. 37). The predetermined conditions are discretionary, and may be a punching action having been performed by the player character, for example. Also, the conditions for restoration of the character object 341 are discretionary. For example, the character object 341 may be restored when a predetermined time has elapsed from the deformation such as partial deletion. The character object 341 may be restored when a condition related to the game (e.g., a predetermined recovery item having been used for the character object 341) is satisfied.

In the example shown in FIG. 37, when the character object 341 is deformed as if a part thereof is deleted, the intersection information set for the character object 341 is deleted (see (b) of FIG. 37). FIG. 37 shows vectors (see solid-line arrows) representing some pieces of intersection information set for the character object 341. In the example shown in FIG. 37, the process of deleting intersection information is the same as the process described in the above [2-7-1. Example of deleting intersection information]. Specifically, the game system 1 sets an intersection information deletion range based on the voxel update range, and deletes intersection information set for voxels in the deletion range.

In the example shown in FIG. 37, when the shape of the character object 341 is restored, the densities of the voxels regarding the character object 341 are restored to the values before deformation (here, the densities are increased). In this case, the game system 1 restores the deleted intersection information (see (c) of FIG. 37). For example, the game system 1 stores the intersection information deleted in the state shown in (b) of FIG. 37, separately from the data used for vertex setting, and restores the intersection information by using the stored data. A mesh of the character object 341 after restoration is generated based on the restored intersection information. This allows the shape of the character object 341 after restoration to be the shape before deformation more accurately. The character object 341 may have a shape that suggests information in the game, such as the shape of an arrow indicating the direction in which the player character 201 should move. In this case, restoring the intersection information allows the shape of the character object 341 after restoration to be the shape that more accurately suggests the information in the game.

### 3. Specific Example of Processing in Game System

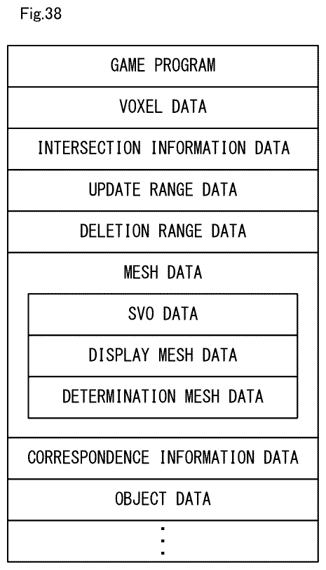

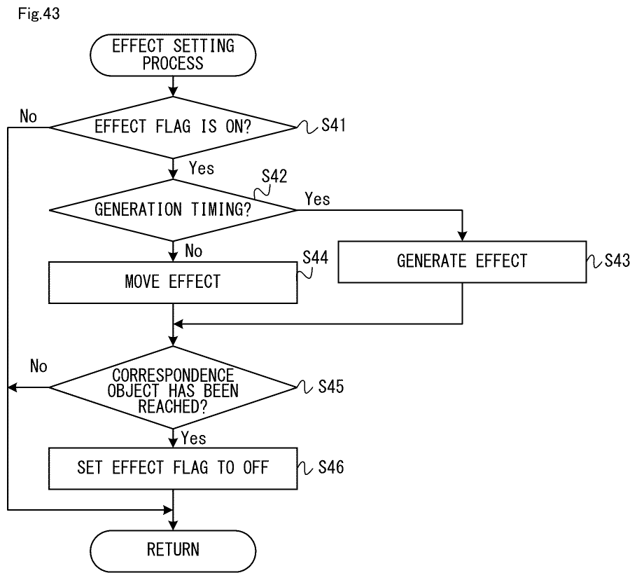

Next, a specific example of information processing in the game system 1 will be described with reference to FIG. 38 and FIG. 43.

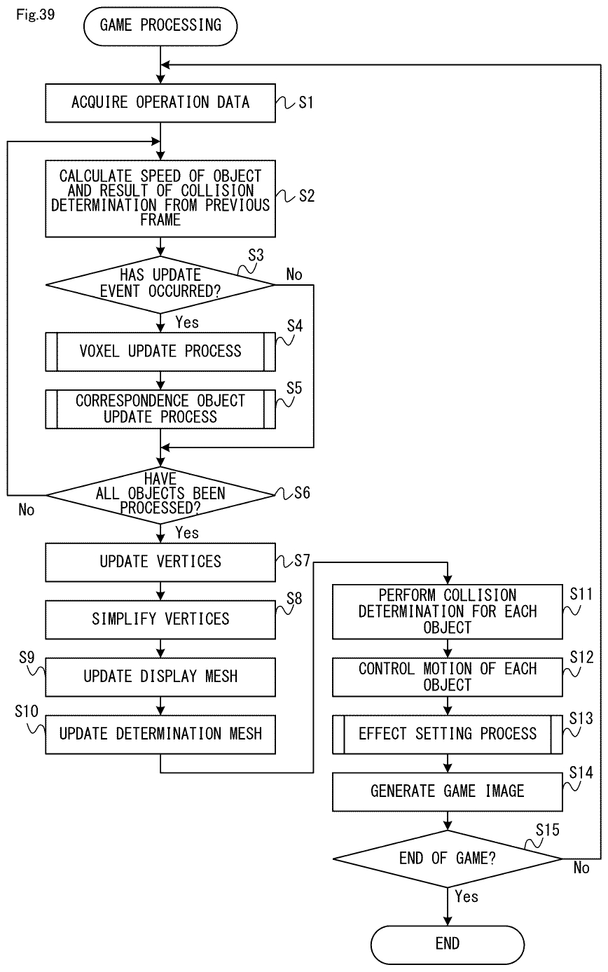

FIG. 38 shows an example of various data used for information processing in the game system 1. The data shown in FIG. 38 are stored in a memory (e.g., the flash memory 84, the DRAM 85, and/or a memory card attached to the slot 23) that is accessible by the main body apparatus 2. As shown in FIG. 38, the game system 1 stores a game program therein. The game program is a program for executing game processing (specifically, game processing shown in FIG. 39) in the exemplary embodiment. The game program includes the aforementioned material data (see FIG. 12). As shown in FIG. 38, in the memory, the aforementioned voxel data (see FIG. 11), the aforementioned intersection information data (see FIG. 18), update range data, deletion range data, mesh data, correspondence information data, object data, and the like.

The update range data is data indicating the aforementioned update range. The deletion range data is data indicating the aforementioned deletion range. In the exemplary embodiment, the update range and the deletion range are represented by the aforementioned SDF.

The mesh data includes various data regarding meshes of a voxel object. As shown in FIG. 38, in the exemplary embodiment, the mesh data includes SVO data, display mesh data, and determination mesh data. The SVO data is data in which vertices calculated from the voxel data are held by the aforementioned SVO structure. In the exemplary embodiment, the SVO data includes data indicating materials set for the vertices (e.g., data indicating IDs of the materials) in addition to data indicating the positions of the vertices. The display mesh data includes various data regarding a display mesh. Specifically, the display mesh data includes data indicating vertices of the display mesh, and data indicating materials set for the vertices (e.g., data indicating IDs of the materials). The determination mesh data includes various data regarding a determination mesh. Specifically, the determination mesh data includes data indicating vertices of the determination mesh, and data indicating materials set for the vertices (data indicating IDs of the materials).

The correspondence information data indicates the aforementioned correspondence information indicating the correspondence relationship between the first correspondence object and the second correspondence object. The correspondence information may indicate, for example, a correspondence between voxel data identification information and voxel data identification information, a correspondence between voxel space identification information and voxel space identification information, or a correspondence between voxel object identification information and voxel object identification information. The correspondence information may be set in advance in the game program. The correspondence relationship may be added, deleted and/or changed under predetermined conditions being satisfied during the game.

The object data includes various data regarding objects (e.g., the player character, the fragment object, etc.) other than the voxel object. The object data is stored for each object that appears in the game space. The object data includes data indicating, for example, the position, speed, state, etc., of the object.

FIG. 39 is a flowchart showing an example of a flow of game processing executed by the game system 1. Execution of the game processing is started in response to the game having been started according to an instruction of the player, during execution of the game program, for example. A processing loop composed of a series of processes in steps S1 to S15 is performed in a cycle of once for each frame.

In the exemplary embodiment, the processor 81 of the main body apparatus 2 executes the game program stored in the game system 1 to execute processes in steps shown in FIG. 39 to 43. However, in other embodiments, a part of the processes in the steps may be executed by a processor (e.g., a dedicated circuit or the like) other than the processor 81. Further, if the game system 1 is communicable with another information processing apparatus (e.g., a server), a part of the processes in the steps shown in FIG. 39 to 43 may be executed by the other information processing apparatus. The processes in the steps shown in FIG. 39 to 43 are merely examples, and the processing order of the steps may be changed, or another process may be executed in addition to (or instead of) the processes in the steps as long as similar results can be obtained.

The processor 81 executes the processes in the steps shown in FIG. 39 to 43 by using a memory (e.g., the DRAM 85). That is, the processor 81 stores information (in other words, data) obtained in each process step, into the memory, and reads out the information from the memory when using the information for the subsequent process steps.

In step S1 shown in FIG. 39, the processor 81 acquires the operation data indicating an operation input performed by the player. That is, the processor 81 acquires the operation data received from the respective controllers via the controller communication section 83 and/or the terminals 17 and 21. Next to step S1, the process in step S2 is executed.

In step S2, the processor 81 designates, as a processing target, an object for which processing has not yet been completed among objects to be processed in the game space, and executes, for the designated object, a process of calculating a speed, and a process of providing (e.g., reflecting) a result of contact between objects in a previous frame. The speed of the object is used for calculating the position of the object in the current frame, in the process of step S11 described below. For example, if the designated object is a player character, the speed of the player character is calculated based on the operation data acquired in step S1. If the designated object is an object (e.g., a fragment object) that is not operated by the player, the speed of the object is calculated based on a rule prescribed in the game program. For example, the speed of the fragment object is set to 0 if the fragment object is disposed on the terrain object and does not move, is set to the same speed as the player character if the fragment object is held by the player character, and is set to a speed at which the fragment object moves in the aim direction with a size determined in the rule if the fragment object has been thrown by a throwing action of the player character. Specifically, the speed of the object is calculated based on a virtual physical calculation including interaction between objects. For example, repulsion due to collision between objects, interaction such as friction due to contact, falling due to virtual gravity, deceleration due to virtual air resistance, or the like is provided in determination of the speed.

The process of providing the result of contact between objects in the previous frame includes a process of, upon determining in the collision determination (step S10) that objects have come into contact with each other, giving an influence due to the contact, to the objects. Examples of this process are as follows.
A process of reducing the hit points of the player character upon determining that the player character has come into contact with the terrain object of lava in the previous frame.
A process of generating a fragment object upon determining that the player character has come into contact with the terrain object due to a pull-out action or a punching action in the previous frame.
A process of causing the fragment object to disappear upon determining that the fragment object has come into contact with the terrain object of rock.

When the state regarding an object has been changed in the process in step S2, the processor 81 updates the corresponding object data stored in the memory regarding the object such that the object data indicates the changed content. Next to step S2, the process in step S3 is executed.

In step S3, the processor 81 determines whether or not an update event that updates the voxel object has been caused by the object designated in step S2. For example, the determination in step S3 is performed based on the result of collision determination (step S10) in the previous frame. For example, when the player character has been determined in the previous frame to come into contact with the voxel object such as a terrain object or a correspondence object due to an action to deform the voxel object, it is determined that an update event has occurred. Specifically, when the player character has been determined to come into contact with the voxel object due to a punching action, it is determined that an update event that deforms the voxel object as if a part thereof is deleted (see FIG. 24, FIG. 28, FIG. 31, and FIG. 37) has occurred. Such an update event includes an event that deforms a terrain object as if a part thereof is deleted, and that changes the material in a range including the deformed part and a surrounding part. For example, when a fragment object has been determined to come into contact with a terrain object of rock in the previous frame, it is determined that an update event that deforms the terrain object as if the fragment object is attached to the terrain object (see FIG. 26) has occurred. For example, if it is determined that the player character has come into contact with the object 332 shown in FIG. 36 due to a predetermined action, it is determined that an update event that deforms the terrain object to rise upward (see FIG. 36) has occurred. Moreover, for example, as in the example shown in FIG. 37, if a condition for restoring the shape of the deformed character object is satisfied, it is determined that an update event that restores the character object has occurred. When the determination result in step S3 is positive, the process in step S4 is executed. When the determination result in step S3 is negative, the process in step S6 is executed.

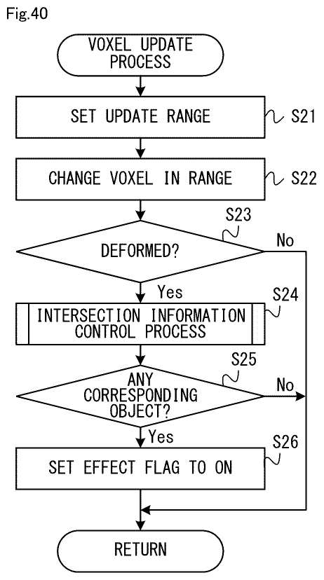

In step S4, the processor 81 executes a voxel update process of updating voxel data regarding the voxel object for which occurrence of an update event has been determined in step S3. Hereinafter, the voxel update process in step S4 will be described in detail with reference to FIG. 40.

FIG. 40 is a sub flowchart showing an example of a specific flow of the voxel update process in step S4 shown in FIG. 39. In the voxel update process, first, in step S21, the processor 81 sets, in the game space, an update range in which voxels of the voxel object are updated. For example, the specific content (e.g., position, shape, and size) of the update range is associated with each of the types of update events in the game program. In step S21, the update range is set so as to have the content associated with the type of the update event that has been determined in step S3 to occur. The processor 81 stores data indicating the set update range, as update range data in the memory. Next to step S21, the process in step S22 is executed.

In step S22, the processor 81 changes the voxels corresponding to the update range set in step S21, according to the update event. For example, in performing deformation such that a voxel object in the update range is deleted or a voxel object is added in the update range, the processor 81 updates the voxel data stored in the memory so as to change the densities of the voxels corresponding to the update range (see the above [2-2. Update of voxel data]). For example, in changing the material of the voxel object in the update range, the processor 81 updates the voxel data stored in the memory so as to update the first and second material IDs and the material mixing ratio of the voxels corresponding to the update range. Next to step S22, the process in step S23 is executed.

In step S23, the processor 81 determines whether or not the voxel object has been deformed in the process in step S22. For example, when the update events shown in FIG. 23, FIG. 24, FIG. 26, FIG. 28, FIG. 30 to FIG. 33, FIG. 36 and FIG. 37 are performed, it is determined that the voxel object has been deformed. When the determination result in step S23 is positive, the process in step S24 is executed. When the determination result in step S23 is negative, the processor 81 ends the voxel update process.

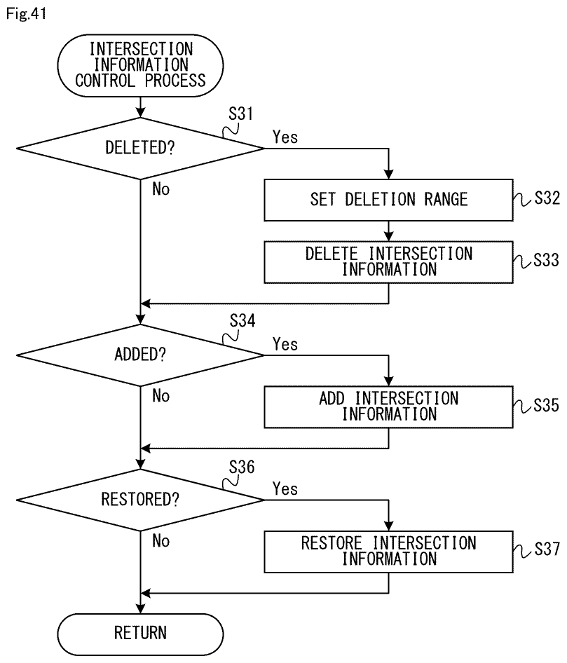

In step S24, the processor 81 executes an intersection information control process. The intersection information control process is a process of performing deletion, addition, or restoration of intersection information for a voxel object having been deformed in the process in step S22. Hereinafter, the intersection information control process in step S24 will be described in detail with reference to FIG. 41.

FIG. 41 is a sub flowchart showing an example of a specific flow of the intersection information control process in step S24 shown in FIG. 40. In the intersection information control process, first, in step S31, the processor 81 determines whether or not to delete intersection information in response to an update event. In the exemplary embodiment, whether the intersection information should be deleted, added, restored, or retained in response to the update event is determined according to the type of the update event, the type of the action that causes the update event, and/or the type of the voxel object to be updated. For example, in the example described in the above [2-7. Process regarding intersection information in response to deformation of voxel object], it is determined to delete the intersection information, for the update event in which the terrain object or the character object is destroyed by the punching action performed by the player character. When the determination result in step S31 is positive, the process in step S32 is executed. When the determination result in step S31 is negative, the process in step S34 is executed.

In step S32, the processor 81 sets a deletion range, based on the update range set in step S21, according to the method described in the above [2-7-1. Example of deleting intersection information]. The processor 81 stores data indicating the set deletion range in the memory as deletion range data. Next to step S32, the process in step S33 is executed.

In step S33, the processor 81 deletes intersection information set for voxels in the deletion range set in step S32. The processor 81 updates the intersection information data stored in the memory so that the intersection information corresponding to the above voxels is deleted. As described above, the processor 81 may simply delete the intersection information from the data used in the series of processes for mesh generation in steps S7 to S10 described below, and may store the intersection information data as data separate from the above data. Next to step S33, the process in step S34 is executed.

In step S34, the processor 81 determines whether or not intersection information should be added in response to an update event. For example, it is determined to add the intersection information, for the update event in which the terrain object is deformed to rise upward by an action performed on the object 332 shown in FIG. 36. When the determination result in step S34 is positive, the process in step S35 is executed. When the determination result in step S34 is negative, the process in step S35 is executed.

In step S35, the processor 81 adds intersection information to some of the voxels whose densities are updated in the process in step S22 described above. For example, the processor 81 determines intersection coordinates and a normal direction of the intersection information to be added, according to the method described in the above [2-7-3. Example of adding intersection information], and stores intersection information data indicating the intersection information in the memory. Next to step S33, the process in step S34 is executed.

In step S36, the processor 81 determines whether or not to restore intersection information in response to an update event. For example, it is determined to restore the intersection information, for the update event that restores the deformed character object 341 shown in FIG. 37. When the determination result in step S36 is positive, the process in step S37 is executed. When the determination result in step S36 is negative, the processor 81 ends the intersection information control process.

In step S37, the processor 81 restores the intersection information for the voxels whose densities are updated in the process in step S22. For example, the processor 81 stores the intersection information data, which was deleted in the process in step S33 due to the previous deformation, as data separate from the data used in the series of processes for mesh generation, and restores the intersection information data by using the above data in step S37. After step S37, the processor 81 ends the intersection information control process.

When the aforementioned correspondence object is deformed, the determination results in steps S31, S34, and S36 are negative. As a result, the intersection information is retained. In other embodiments, when the voxel density of the correspondence object is decreased in the process of step S22, the processor 81 may delete the intersection information set for the voxels in the process of step S33. In this case, when the process in step S35 is performed on a correspondence object corresponding to the correspondence object whose intersection information has been deleted, the processor 81 may set the same intersection information as the deleted intersection information, in the process in step S35.

Referring back to FIG. 39, in step S25 next to step S24, the processor 81 determines whether or not the voxel object, for which occurrence of the update event has been determined in step S3, is a correspondence object described above, i.e., whether or not there is a voxel object corresponding to the voxel object. This determination is performed, for example, according to whether or not the correspondence information data stored in the memory includes a voxel object corresponding to the voxel object. When the determination result in step S25 is positive, the process in step S26 is executed. When the determination result in step S25 is negative, the processor 81 ends the voxel update process.

In step S26, the processor 81 sets an effect flag to ON for the voxel object for which occurrence of the update event has been determined in step S3. The effect flag is a flag that indicates whether or not an effect image to be displayed when the correspondence object is deformed (see FIG. 31 and FIG. 33) is occurring. The effect flag is set for each correspondence object. When the effect flag is ON, setting regarding display of the effect image is performed in an effect control process described below (step S13), and a game image including the effect image is generated in the process in step S14. After step S26, the processor 81 ends the voxel update process.

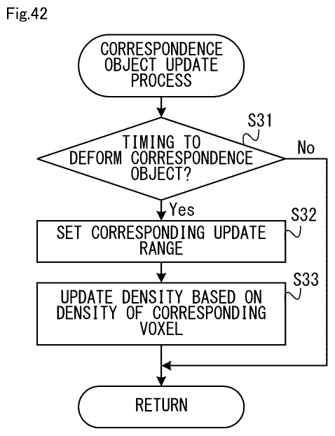

Referring back to FIG. 39, in step S5 next to the voxel update process in step S4, the processor 81 executes a correspondence object update process. The correspondence object update process is a process of updating voxel data under certain conditions when the object designated in step S2 is a correspondence object. Hereinafter, the correspondence object update process in step S5 will be described in detail with reference to FIG. 42.

FIG. 42 is a sub flowchart showing an example of a specific flow of the correspondence object update process in step S5 shown in FIG. 39. In the correspondence object update process, first, in step S41, the processor 81 determines whether or not the voxel object designated in step S2 is a correspondence object and whether or not a timing to perform deformation in response to deformation of a voxel object corresponding to the voxel object has arrived. In the exemplary embodiment, the timing is a timing at which an effect image that occurs in response to deformation of a voxel object corresponding to the voxel object has arrived at the position of the voxel object. Therefore, determination in step S41 can be performed depending on whether or not a process in step S55 has been executed because the determination result in step S56 in an effect control process described later is positive. The determination result in step S41 is negative if the voxel object designated in step S2 is not a correspondence object, a voxel object corresponding to the voxel object is not deformed, or the above timing has not arrived yet although the corresponding voxel object is deformed. When the determination result in step S41 is positive, the process in step S42 is executed. When the determination result in step S41 is negative, the processor 81 ends the correspondence object update process.

In step S42, the processor 81 sets an update range for updating densities, for the voxel object designated in step S2. This update range corresponds to the update range that is set in step S21 executed for a voxel object corresponding to the voxel object designated in step S2. The update range is set based on the corresponding update range, according to the method described in the above [2-7. Process of changing shapes of two voxel objects]. The processor 81 stores data indicating the set update range, as update range data in the memory. Next to step S42, the process in step S43 is executed.

In step S43, the processor 81 updates the density of each voxel in the update range set in step S42. Specifically, the updated density of the voxel is calculated based on the density of a voxel corresponding to the voxel, according to the method described in the above [2-7. Process of changing shapes of two voxel objects]. The processor 81 updates the voxel data stored in the memory so that the voxel data indicates the calculated density value. After step S43, the processor 81 ends the correspondence object update process.

Referring back to FIG. 39, in step S6 next to the correspondence object update process in step S5, the processor 81 determines whether or not all the objects to be processed have been subjected to the processes in step S2 to S5. When the determination result in step S6 is positive, the process in step S7 is executed. When the determination result in step S6 is negative, the process in step S2 is again executed.

In step S7, the processor 81 updates the vertices of the voxel object in the game space. That is, when the voxel data has been updated in the process in step S4 or S5, new vertices are calculated based on the updated voxel data. The positions and materials of the new vertices are calculated according to the method described in the above [2-3. Calculation of vertices]. Next to step S7, the process in step S8 is executed.

In step S8, the processor 81 performs simplification for the vertices. That is, the processor 81 performs simplification for the vertices updated in the process in step S7, according to the method described in the above [2-4. Simplification of vertices]. The SVO data stored in the memory is updated so as to indicate the vertices obtained through the processes in steps S7 and S8. Therefore, update of the SVO data is performed through the processes in steps S7 and S8. The processes in steps S7 and S8 may not necessarily calculate new vertices for the entirety of the voxel data, and may be performed only for the part in which the content of the voxels has been changed in the process in step S4 or S5. Next to step S8, the process in step S9 is executed.

In step S9, the processor 81 updates the display mesh of the voxel object, based on the SVO data stored in the memory. The positions of the vertices of the display mesh and the materials of the polygons in the display mesh (e.g., the materials set for the vertices of the polygons) are calculated according to the method described in the above [2-5. Generation of mesh]. The processor 81 updates the display mesh data stored in the memory so as to indicate the positions and materials of the vertices of the updated display mesh. Next to step S9, the process in step S10 is executed. The processor 81 may start the process in step S10 and subsequent steps without waiting for completion of step S9 to execute these steps in parallel with step S9. In this case, step S9 needs to be completed before start of step S14.

In step S10, the processor 81 updates the determination mesh of the voxel object, based on the SVO data stored in the memory. The positions of the vertices of the determination mesh and the materials of the polygons in the determination mesh (e.g., the materials set for the vertices of the polygons) are calculated according to the method described in the above [2-5. Generation of mesh]. The processor 81 updates the determination mesh data stored in the memory so as to indicate the positions and materials of the vertices of the updated determination mesh. Next to step S10, the process in step S11 is executed.

In the example shown in FIG. 39, the determination mesh generation process (step S10) is executed for each frame, but the determination mesh generation process may not necessarily be executed for each frame. For example, in the case where the collision determination process in step S11 is executed only for a frame that satisfies a predetermined condition, the processor 81 may execute the determination mesh generation process in the frame in which the collision determination in step S11 is performed. In addition, the processor 81 may execute the determination mesh generation process for voxels in a region, in the game space, where the collision determination in step S11 is performed. For example, in a situation where, in the game space, an object to be subjected to collision determination does not exist around the player character, except for a voxel object (e.g., a situation where only collision determination between the player character and the neighboring voxel object needs to be performed), the processor 81 may execute the determination mesh generation process for voxels within a predetermined range based on the player character.

In step S11, the processor 81 performs collision determination for each object in the game space, based on the determination mesh data and the object data stored in the memory. That is, the processor 81 performs collision determination by using a determination mesh for a voxel object, and using, for an object that is not a voxel object, a determination region having a predetermined shape, which is set for the object. In the exemplary embodiment, the collision determination in step S11 is performed in consideration of the speed calculated in step S2. That is, the processor 81 performs collision determination by using, as the position of each object, the position to which the object moves at the speed.

In the exemplary embodiment, presence/absence of the following contacts is determined by the collision determination in step S11.
Contact of the player character that moves or performs a punching action or a pull-out action, with the voxel object such as terrain object.
Contact of a character that perform an action of lifting (a fragment object) with the fragment object.
Contact of a straight line extending in the aim direction from the position of the player character, with the voxel object.
Contact of a fragment object thrown by a throwing action of the player character, with the voxel object.

When the result of the collision determination in step S11 is that the objects have come into contact with each other, a process of determining (e.g., generating) the result of the contact of the objects is performed in step S2 in the next frame, or it is determined in step S3 in the next frame that an update event has occurred. Next to step S11, the process in step S12 is executed.

In step S12, the processor 81 controls the motion of each object in the game space. For example, as for the player character, the processor 81 performs a control that causes the player character to move or perform various actions, based on the operation data acquired in step S1. When a predetermined action has occurred, a region for collision determination according to the action is generated in the game space. For example, a fragment object is controlled to move in the aim direction in response to a throwing action of the player character that throws the fragment object. In a single process in step S12, as for a motion (e.g., an action of the player character) that is performed over a plurality of frames, the processor 81 controls each object so as to progress the motion for one frame. By the process in step S12 being repeatedly executed over a plurality of frames, each object performs a series of motions regarding movement and various actions. The position of each object is basically determined to be the position after the object has moved with the speed calculated in step S2. However, in the case where an object is determined to come into contact with another object by the collision determination in step S11 and movement of this object is prevented by the other object, the position of the object is determined not to be changed. The object data stored in the memory is updated so as to have the content indicating the object after the control in step S12. Next to step S12, the process in step S13 is executed.

In step S13, the processor 81 executes an effect setting process. The effect setting process is a process of performing setting regarding an effect image to be displayed in response to deformation of a correspondence object. Hereinafter, the effect setting process in step S13 will be described in detail with reference to FIG. 43.

FIG. 43 is a sub flowchart showing an example of a specific flow of the effect setting process in step S13 shown in FIG. 39. In the effect setting process, first, in step S51, the processor 81 determines whether or not there is a correspondence object for which an effect flag is set to ON. When the determination result in step S51 is positive, the process in step S52 is executed. When the determination result in step S51 is negative, the processor 81 ends the effect setting process.

In step S52, the processor 81 determines whether or not it is the timing when an effect image is generated. The determination in step S52 is made, for example, based on whether or not the effect flag is set to ON by the process in step S25 during the process of the current frame in the process loop of steps S1 to S15. When the determination result in step S52 is positive, the process in step S53 is executed. When the determination result in step S52 is negative, the process in step S54 is executed.

In step S53, the processor 81 newly generates an effect image. Specifically, display setting is performed such that the new effect image is placed at the position of the voxel object for which the effect flag is set to ON through the process in step S25. The effect image display method is discretionary. For example, an object representing the effect image may be placed in the virtual space. The specific start position where the effect image is placed is determined based on the method described in the above [2-7. Process of changing shapes of two voxel objects]. In this case, the processor 81 stores, in the memory, data indicating the position where the effect image is placed. When the display setting has been performed, a game image including the effect image is generated and displayed in the process in step S14 described below. The process in step S55 is executed next to step S53.

In step S54, the processor 81 moves the position of the placed effect image. In the exemplary embodiment, the processor 81 moves the effect image at a predetermined speed along a predetermined trajectory from the current position to the target position. In a single execution of step S54, the position, to which the effect image is moved from the current position by a distance equivalent to movement during one frame, is calculated, and the calculated position is the position of the effect image after movement. The processor 81 stores, in the memory, data indicating the calculated position after movement. The target position is the position of a voxel object corresponding to the voxel object for which the effect flag is set to ON. The target position is determined based on the method described in the above [2-7. Process of changing shapes of two voxel objects]. Specifically, the predetermined trajectory may be any trajectory, for example, a parabolic trajectory connecting the start position and the target position. Next to step S54, the process in step S55 is executed.

In step S55, the processor 81 determines whether or not the effect image has arrived at the voxel object corresponding to the voxel object for which the effect flag is set to ON. Specifically, the processor 81 determines whether or not the position after movement, calculated in step S54, has arrived at the target position. When the determination result in step S55 is positive, the process in step S56 is executed. When the determination result in step S55 is negative, the processor 81 ends the effect setting process.

In step S56, the processor 81 sets the effect flag to OFF. Thus, in the process in step S14 described below, the effect image corresponding to the effect flag is no longer displayed. After step S56, the processor 81 ends the effect setting process.

In the effect setting process shown in FIG. 43, one effect image is displayed. However, a plurality of effect images may be simultaneously displayed. In this case, the processor 81 executes the processes in steps S52 to S56 for each effect image that is placed.

Referring back to FIG. 39, in step S14 next to the effect setting process in step S13, the processor 81 generates a game image. That is, the processor 81 generates a game image by performing rendering, based on the virtual camera, for the polygons of the display mesh of the voxel object, and the polygons of objects other than the voxel object. The polygons of the display mesh are rendered by using rendering setting such as textures corresponding to materials set for the polygons. Also, in the exemplary embodiment, if the display setting for generating an effect image has been made through the process in step S13, a game image including an effect image to be placed at the position calculated in step S53 or S54 is generated (see (FIG. 31 and FIG. 33). If the player character is capable of performing a throwing action, the processor 81 generates a game image so as to include the aforementioned aim image and object information image (see FIG. 25). The game image generated in step S14 is outputted to the display device and displayed in a cycle of once for each frame.

In step S15, the processor 81 determines whether or not to end the game. For example, the processor 81 determines to end the game when a predetermined operation input to end the game has been performed by the player. When the determination result in step S15 is negative, the process in step S1 is executed again. Thereafter, a series of processes in steps S1 to S15 is repeated until the processor 81 determines to end the game in step S15. When the determination result in step S15 is positive, the processor 81 ends the game processing shown in FIG. 39.

### 4. Function and Effect of the Exemplary Embodiment, and Modifications

In the above exemplary embodiment, a voxel mesh is generated based on densities and intersection information set for voxels. When the densities of voxels corresponding to an update range are decreased, intersection information set for voxels corresponding to a deletion range is deleted. Thus, an increase in processing load in the process of generating the voxel mesh using the intersection information can be suppressed.

In the above exemplary embodiment, update of voxel densities and deletion of intersection information are performed according to an action performed by the player character. However, update of voxel densities and deletion of intersection information may be performed according to any conditions in the game. For example, update of voxel densities and deletion of intersection information may be performed in response to passage of a predetermined time from a certain timing in the game.

In the exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the other information processing apparatus and the data stored therein.

In other embodiments, the information processing system may not include some of the components in the above embodiment, and may not execute some of the processes executed in the above embodiment. For example, in order to achieve a specific effect of a part of the above embodiment, the information processing system includes a configuration for achieving the effect and executes a process for achieving the effect, and need not include other configurations and need not execute other processes.

The above exemplary embodiment can be used as, for example, a game system or a game program, for the purpose of suppressing an increase in processing load in the process of generating a mesh of an object.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors to execute information processing comprising:
generating and updating a voxel mesh based on voxel data, defined in a voxel space in a virtual space, in which at least a density is set for each of a plurality of voxels, the density indicating a degree of occupation of a content in a space defined by the voxel, and in which intersection information regarding an intersection of a mesh and a line connecting voxels is set for at least some voxels, wherein vertex coordinates of the voxel mesh are determined based on at least the densities and the intersection information;
based on an operation input, controlling a player character in the virtual space, and causing the player character to perform a first action in response to a first user instruction based on the operation input;
decreasing the densities of voxels in the voxel data corresponding to a first voxel update range that is set based on a position where the first action is performed, and deleting the intersection information if the intersection information is set for voxels in the voxel data corresponding to a first intersection information update range that is set based on the position where the first action is performed; and
rendering the virtual space including the voxel mesh.

2. The one or more non-transitory computer-readable media according to claim 1, wherein
the intersection information includes, for each voxel, data indicating coordinates of an intersection and data indicating a normal direction, the intersection being an intersection between a mesh and a boundary between the voxel and an adjacent voxel in a first direction,
a vertex of the voxel mesh is set between a voxel whose density has a value in a first range and a voxel whose density has a value in a second range,
regarding a voxel for which the intersection information is set, coordinates of the vertex of the voxel mesh are determined, based on the intersection information, at a position where a plane of the voxel mesh is arranged facing the normal direction at the coordinates of the intersection, or an error of the plane of the voxel mesh from the arrangement is minimized, and
the information processing comprises,
regarding a voxel for which intersection information is not set, based on an intersection that is set based on the density, generating and updating the voxel mesh based on determining the coordinates of the vertex of the voxel mesh.

3. The one or more non-transitory computer-readable media according to claim 2, wherein
the information processing comprises generating and updating the voxel mesh, based on determining the coordinates of the vertex of the voxel mesh at a position where the distance from a plurality of planes, which are based on a plurality of pieces of intersection information and face the normal direction at the coordinates of intersection, is minimized.

4. The one or more non-transitory computer-readable media according to claim 1, wherein
the information processing further comprises:
causing the player character to perform a second action in response to a second user instruction based on an operation input; and
for voxels in the voxel data corresponding to a second voxel update range that is set in response to the second action, decreasing the densities without deleting the intersection information.

5. The one or more non-transitory computer-readable media according to claim 4, wherein
the voxel data includes first voxel data defined in a first voxel space and second voxel data defined in a second voxel space,
the first action is an action for the first voxel data, and the first voxel update range is an update range for the first voxel data, and
the second action is an action for the second voxel data, and the second voxel update range is an update range for the second voxel data.

6. The one or more non-transitory computer-readable media according to claim 5, wherein
the voxel data further includes third voxel data which is defined in a third voxel space, and in which, for each of a plurality of voxels, a correspondence relationship with each of voxels in the second voxel data is set, and
the information processing further comprises,
when the density of a voxel in the second voxel data is decreased, increasing the density of an increase target voxel which is a voxel in the third voxel data and on which the correspondence relationship with a decrease target voxel, which is the voxel whose density is decreased, is set.

7. The one or more non-transitory computer-readable media according to claim 1, wherein
the voxel data further includes:
first voxel data defined in a first voxel space;
second voxel data defined in a second voxel space; and
third voxel data which is defined in a third voxel space, and in which, for each of a plurality of voxels, a correspondence relationship with each of voxels in the second voxel data is set, and
the information processing further comprises:
when the density of a voxel in the second voxel data is decreased based on the first action, increasing the density of an increase target voxel which is a voxel in the third voxel data and on which the correspondence relationship with a decrease target voxel, which is the voxel whose density is decreased, is set; and
when the intersection information has been set for the decrease target voxel, setting the same intersection information as the intersection information deleted from the decrease target voxel, on the increase target voxel.

8. The one or more non-transitory computer-readable media according to claim 1, wherein
the information processing further comprises:
causing the player character to perform a third action in response to a third user instruction based on an operation input; and
for voxels in the voxel data corresponding to a third voxel update range that is set in response to the third action, updating the densities of the voxels, and setting the intersection information for at least some of the voxels.

9. The one or more non-transitory computer-readable media according to claim 1, wherein
the voxel data includes at least fourth voxel data which is defined in a fourth voxel space and in which the intersection information is set for at least some of the voxels, and
the information processing further comprises,
when the density of a voxel in the fourth voxel data is decreased based on the first action, for a voxel in the fourth voxel data corresponding to a fourth voxel update range, increasing the density of the voxel and restoring the intersection information deleted based on the first action.

10. An information processing system comprising:
one or more processors,
one or more memories having stored therein computer-executable instructions to execute information processing comprising:
generating and updating a voxel mesh based on voxel data, defined in a voxel space in a virtual space, in which at least a density is set for each of a plurality of voxels, the density indicating a degree of occupation of a content in a space defined by the voxel, and in which intersection information regarding an intersection of a mesh and a line connecting voxels is set for at least some voxels, wherein vertex coordinates of the voxel mesh are determined based on at least the densities and the intersection information;
based on an operation input, controlling a player character in the virtual space, and causing the player character to perform a first action in response to a first user instruction based on the operation input;
decreasing the densities of voxels in the voxel data corresponding to a first voxel update range that is set based on a position where the first action is performed, and deleting the intersection information if the intersection information is set for voxels in the voxel data corresponding to a first intersection information update range that is set based on the position where the first action is performed; and
rendering the virtual space including the voxel mesh.

11. The information processing system according to claim 10, wherein
the intersection information includes, for each voxel, data indicating coordinates of an intersection and data indicating a normal direction, the intersection being an intersection between a mesh and a boundary between the voxel and an adjacent voxel in a first direction,
a vertex of the voxel mesh is set between a voxel whose density has a value in a first range and a voxel whose density has a value in a second range,
regarding a voxel for which the intersection information is set, coordinates of the vertex of the voxel mesh are determined, based on the intersection information, at a position where a plane of the voxel mesh is arranged facing the normal direction at the coordinates of the intersection, or an error of the plane of the voxel mesh from the arrangement is minimized, and
the information processing comprises,
regarding a voxel for which intersection information is not set, based on an intersection that is set based on the density, generating and updating the voxel mesh based on determining the coordinates of the vertex of the voxel mesh.

12. The information processing system according to claim 11, wherein
the information processing comprises generating and updating the voxel mesh, based on determining the coordinates of the vertex of the voxel mesh at a position where the distance from a plurality of planes, which are based on a plurality of pieces of intersection information and face the normal direction at the coordinates of intersection, is minimized.

13. The information processing system according to claim 10, wherein
the information processing further comprises:
causing the player character to perform a second action in response to a second user instruction based on an operation input; and
for voxels in the voxel data corresponding to a second voxel update range that is set in response to the second action, decreasing the densities without deleting the intersection information.

14. The information processing system according to claim 13, wherein
the voxel data includes first voxel data defined in a first voxel space and second voxel data defined in a second voxel space,
the first action is an action for the first voxel data, and the first voxel update range is an update range for the first voxel data, and
the second action is an action for the second voxel data, and the second voxel update range is an update range for the second voxel data.

15. The information processing system according to claim 14, wherein
the voxel data further includes third voxel data which is defined in a third voxel space, and in which, for each of a plurality of voxels, a correspondence relationship with each of voxels in the second voxel data is set, and
the information processing further comprises,
when the density of a voxel in the second voxel data is decreased, increasing the density of an increase target voxel which is a voxel in the third voxel data and on which the correspondence relationship with a decrease target voxel, which is the voxel whose density is decreased, is set.

16. The information processing system according to claim 10, wherein
the voxel data further includes
first voxel data defined in a first voxel space,
second voxel data defined in a second voxel space, and
third voxel data which is defined in a third voxel space, and in which, for each of a plurality of voxels, a correspondence relationship with each of voxels in the second voxel data is set, and
the information processing further comprises,
when the density of a voxel in the second voxel data is decreased based on the first action, increasing the density of an increase target voxel which is a voxel in the third voxel data and on which the correspondence relationship with a decrease target voxel, which is the voxel whose density is decreased, is set, and
when the intersection information has been set for the decrease target voxel, setting the same intersection information as the intersection information deleted from the decrease target voxel, on the increase target voxel.

17. The information processing system according to claim 10, wherein
the information processing further comprises:
causing the player character to perform a third action in response to a third user instruction based on an operation input; and
for voxels in the voxel data corresponding to a third voxel update range that is set in response to the third action, updating the densities of the voxels, and setting the intersection information for at least some of the voxels.

18. The information processing system according to claim 10, wherein
the voxel data includes at least fourth voxel data which is defined in a fourth voxel space and in which the intersection information is set for at least some of the voxels, and
the information processing further comprises,
when the density of a voxel in the fourth voxel data is decreased based on the first action, for a voxel in the fourth voxel data corresponding to a fourth voxel update range, increasing the density of the voxel and restoring the intersection information deleted based on the first action.

19. A game processing method performed on an information processing system, the game processing method comprising:
generating and updating a voxel mesh based on voxel data, defined in a voxel space in a virtual space, in which at least a density is set for each of a plurality of voxels, the density indicating a degree of occupation of a content in a space defined by the voxel, and in which intersection information regarding an intersection of a mesh and a line connecting voxels is set for at least some voxels, wherein vertex coordinates of the voxel mesh are determined based on at least the densities and the intersection information;
based on an operation input, controlling a player character in the virtual space, and causing the player character to perform a first action in response to a first user instruction based on the operation input;
decreasing the densities of voxels in the voxel data corresponding to a first voxel update range that is set based on a position where the first action is performed, and deleting the intersection information if the intersection information is set for voxels in the voxel data corresponding to a first intersection information update range that is set based on the position where the first action is performed; and
rendering the virtual space including the voxel mesh.

20. The game processing method according to claim 19, wherein
the intersection information includes, for each voxel, data indicating coordinates of an intersection and data indicating a normal direction, the intersection being an intersection between a mesh and a boundary between the voxel and an adjacent voxel in a first direction,
a vertex of the voxel mesh is set between a voxel whose density has a value in a first range and a voxel whose density has a value in a second range,
regarding a voxel for which the intersection information is set, coordinates of the vertex of the voxel mesh are determined, based on the intersection information, at a position where a plane of the voxel mesh is arranged facing the normal direction at the coordinates of the intersection, or an error of the plane of the voxel mesh from the arrangement is minimized, and
the game processing method comprises,
regarding a voxel for which intersection information is not set, based on an intersection that is set based on the density, generating and updating the voxel mesh based on determining the coordinates of the vertex of the voxel mesh.

21. The game processing method according to claim 20, comprises
generating and updating the voxel mesh, based on determining the coordinates of the vertex of the voxel mesh at a position where the distance from a plurality of planes, which are based on a plurality of pieces of intersection information and face the normal direction at the coordinates of intersection, is minimized.

22. The game processing method according to claim 19, further comprises:
causing the player character to perform a second action in response to a second user instruction based on an operation input; and
for voxels in the voxel data corresponding to a second voxel update range that is set in response to the second action, decreasing the densities without deleting the intersection information.

23. The game processing method according to claim 22, wherein
the voxel data includes first voxel data defined in a first voxel space and second voxel data defined in a second voxel space,
the first action is an action for the first voxel data, and the first voxel update range is an update range for the first voxel data, and
the second action is an action for the second voxel data, and the second voxel update range is an update range for the second voxel data.

24. The game processing method according to claim 23, wherein
the voxel data further includes third voxel data which is defined in a third voxel space, and in which, for each of a plurality of voxels, a correspondence relationship with each of voxels in the second voxel data is set, and
the game processing method further comprises,
when the density of a voxel in the second voxel data is decreased, increasing the density of an increase target voxel which is a voxel in the third voxel data and on which the correspondence relationship with a decrease target voxel, which is the voxel whose density is decreased, is set.

25. The game processing method according to claim 19, wherein
the voxel data further includes
first voxel data defined in a first voxel space,
second voxel data defined in a second voxel space, and
third voxel data which is defined in a third voxel space, and in which, for each of a plurality of voxels, a correspondence relationship with each of voxels in the second voxel data is set, and
the game processing method further comprises,
when the density of a voxel in the second voxel data is decreased based on the first action, increasing the density of an increase target voxel which is a voxel in the third voxel data and on which the correspondence relationship with a decrease target voxel, which is the voxel whose density is decreased, is set, and
when the intersection information has been set for the decrease target voxel, setting the same intersection information as the intersection information deleted from the decrease target voxel, on the increase target voxel.

26. The game processing method according to claim 19, further comprises:
causing the player character to perform a third action in response to a third user instruction based on an operation input; and
for voxels in the voxel data corresponding to a third voxel update range that is set in response to the third action, updating the densities of the voxels, and setting the intersection information for at least some of the voxels.

27. The game processing method according to claim 19, wherein
the voxel data includes at least fourth voxel data which is defined in a fourth voxel space and in which the intersection information is set for at least some of the voxels, and
the game processing method further comprises,
when the density of a voxel in the fourth voxel data is decreased based on the first action, for a voxel in the fourth voxel data corresponding to a fourth voxel update range, increasing the density of the voxel and restoring the intersection information deleted based on the first action.
